(19) United States
(12) Patent Application Publication
(10) Pub. No.: US 2006/0181774 A1
(43) Pub. Date: Aug. 17, 2006

(54) Antireflection film, production method of the same, polarizing plate and display

(75) Inventors: Yoshikazu Ojima, Tokyo (JP); Katsumi Maejima, Tokyo (JP); Toshiyuki Ikeda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 11/352,826

(22) Filed: Feb. 13, 2006

(30) Foreign Application Priority Data
Feb. 16, 2005 (JP) JP2005-038960

(51) Int. Cl. G02B 1/10

(52) U.S. Cl. 359/586

(57) ABSTRACT

An antireflection film comprising a transparent substrate film having thereon a hard coat, a high refractive index layer and a low refractive index layer, wherein: (i) the high refractive index layer is formed by applying a coating solution containing the following (a) to (c); (ii) the low refractive index layer is formed by applying a coating solution containing the following (d) and (e); (iii) the antireflection film is heat treated, wherein (a) metal oxide particles having an average primary particle diameter of 10 to 200 nm; (b) a metal compound; (c) an ionizing radiation curable resin; (d) an organosilicon compound having a prescribed structure, a hydrolyzed compound of the organosilicon compound, a decomposed compound of the organosilicon compound or a polycondensed compound of the organosilicon compound; and (e) hollow silica particles each having an outer shell, and a void or a porous portion in the inside.

This application is based on Japanese Patent Application No. 2005-038960 filed on Feb. 16, 2005 Japanese Patent Office, the entire content of which is hereby incorporated by reference.

### FIELD OF THE INVENTION

The present invention relates to an antireflection film, a production method of the same, a polarizing plate and a display.

### BACKGROUND OF THE INVENTION

With respect to an antireflection film used on the outermost surface of a display, for example, a liquid crystal display, proposed has been a technique to form a low reflectivity surface by providing an antireflection film using optical interference.

In order to lower the reflectivity, a technique to lower the refractive index of the low refractive index layer on the outer most surface of a display has been proposed, in which proposed has been a method to use a low refractive index material or to increase the number and/or volume of voids in the layer to lower the refractive index. However, any of these techniques tend to result in deterioration of hardness of the antireflective film (expressed, for example, by pencil hardness) or of the scratch resistance of the antireflection film.

Recently, a technique to use hollow silica particles has been proposed (refer to Patent Documents 1-3). The hollow silica particle has an outer shell and a void or a porous portion in the inside. This technique provides a low refractive index due to the voids in the hollow silica particles while improving the hardness of the film. However, the film hardness has not been fully enough and the film hardness of the film containing 20% by weight or more of hollow particles tends to become lower than the practical film hardness.

Employed has been a method to form a metal oxide layer on a support by applying titanium alkoxide or silane alkoxide on the support, followed by drying and then heating. However, this method may give damage to the support since a temperature of 300° C. or more is necessary, and when the temperature is relatively low, for example, 100° C., rather long period is needed, which is not favorable for production.

As the methods to form a metal oxide layer, known are: (i) a method to form a silica film via a sol-gel process(refer to Patent Document 5); and (ii) a method to form a low refractive index layer via a sol-gel process (refer to Patent Document 5), both of which result in giving not fully sufficient scratch resistance.

The method to use a fluorine-containing resin as a binder has been known (for example, refer to Patent Documents 6-8) which also gives a low refractive index, however the film hardness of the resulting films are not fully enough. Namely, there may be a trade-off relationship between a low refractive index and film hardness.

Also known is a method so-called curing or aging which is used for improving the hardness of an antireflection film or for hardening the antireflection film in a short time after an antireflection layer is formed on a support (for example, refer to Patent Documents 9 and 10). In these patent documents, it is disclosed that an optical film exhibiting a high surface hardness is obtained by heat treating the optical film at a temperature of 40-150° C. for a duration of 30 minutes to several weeks under a wound state in a roll after an antireflection layer is formed and then dried. However, some of these methods may result in deterioration of flatness of the optical film due to the heat deformation caused by the heat treatment, specifically in the production of a wide optical film.

Patent Document 1: JP-A No. 2001-167637 (being Japanese Patent Publication Open to Public Inspection)

Patent Document 2: JP-A No. 2001-233611

Patent Document 3: JP-A No. 2002-79616

Patent Document 4: JP-A No. 11-269657

Patent Document 5: JP-A No. 2000-910

Patent Document 6: JP-A No. 2003-236970

Patent Document 7: JP-A No. 2003-240906

Patent Document 8: JP-A No. 2003-255103

Patent Document 9: JP-A No. 2001-91705

Patent Document 10: JP-A No. 2002-6104

### SUMMARY OF THE INVENTION

An object of the present invention is to provide an antireflection film exhibiting improved scratch resistance, pencil hardness, crack resistance, heiz, light resistance and flatness, and a production method thereof as well as to provide a polarizing plate and a display exhibiting an excellent visibility by using the antireflection film.

One of the aspects of the present invention is an antireflection film containing a transparent substrate film having thereon a hard coat film having a layer thickness of 8 to 20 μm, a high refractive index layer having a refractive index higher than a refractive index of the substrate film and a low refractive index layer having a refractive index lower than the refractive index of the substrate film, wherein: (i) the high refractive index layer is formed by applying a coating liquid containing the following (a) to (c); (ii) the low refractive index layer is formed by applying a coating liquid containing the following (d) and (e); (iii) the antireflection film is heat treated, wherein (a) metal oxide particles having an average particle diameter of 10 to 200 nm; (b) a metal compound; (c) an ionizing radiation curable resin; (d) an organosilicon compound having a prescribed structure, a hydrolyzed compound of the organosilicon compound, a decomposed compound of the organosilicon compound or a polycondensed compound of the organosilicon compound; and (e) hollow silica particles each having an outer shell and a void or a porous portion in the inside.

Another aspect of the present invention is a A method for producing an antireflection film containing the steps of: (i) producing a transparent substrate film; (ii) forming a hard coat layer having a thickness of 8 to 20 μm on the transparent substrate film; (iii) forming a high refractive index layer having a refractive index higher than a refractive index of the substrate film by applying a coating liquid containing the following (a) to (c); (iv) forming a low refractive index layer having a refractive index lower than the refractive index of the substrate film by applying a coating liquid containing the following (d) and (e); and (v) heat treating the antireflection film, wherein (a) metal oxide particles having an average particle diameter of 10 to 200 nm; (b) a metal compound; (c) an ionizing radiation curable resin; (d) an organosilicon compound having a prescribed structure, a hydrolyzed compound of the organosilicon compound, a decomposed compound of the organosilicon compound or a polycondensed compound of the organosilicon compound; and (e) hollow silica particles each having an outer shell and a void or a porous portion in the inside.

### DESCRIPTION OF THE PREFERRED EMBODIMENTS

The above object of the present invention is achieved by the following structures:

(1) An antireflection film containing a transparent substrate film having thereon a hard coat layer having a layer thickness of 8 to 20 μm, a high refractive index layer having a refractive index higher than a refractive index of the substrate film and a low refractive index layer having a refractive index lower than the refractive index of the substrate film, wherein

(i) the high refractive index layer is formed by applying a coating liquid containing the following (a) to (c);

(ii) the low refractive index layer is formed by applying a coating liquid containing the following (d) and (e);

(iii) the antireflection film is heat treated,

wherein
(a) metal oxide particles having an average primary particle diameter of 10 to 200 nm;
(b) a metal compound;
(c) an ionizing radiation curable resin;
(d) an organosilicon compound represented by Formula (1), a hydrolyzed compound of the organosilicon compound, a decomposed compound of the organosilicon compound or a polycondensed compound of the organosilicon compound,
   Si(OR)₄ Formula (1)

wherein R represents an alkyl group; and
(e) hollow silica particles each having an outer shell, and a void or a porous portion in the inside.

(2) The antireflection film of Item (1), wherein R represents an alkyl group having 1 to 4 carbon atoms.

(3) The antireflection film of Item (1) or Item (2), wherein

the transparent substrate film contains a plasticizer and a cellulose ester; and

the cellulose ester has a free volume radius determined by positron annihilation lifetime spectroscopy in the range of 0.250 to 0.310 nm.

(4) A method for producing an antireflection film containing the steps of:

(i) producing a transparent substrate film by casting a dope on a support;.

(ii) forming a hard coat layer having a thickness of 8 to 20 μm on the transparent substrate film;

(iii) forming a high refractive index layer having a refractive index higher than a refractive index of the substrate film by applying a coating liquid containing the following (a) to (c);

(iv) forming a low refractive index layer having a refractive index lower than the refractive index of the substrate film by applying a coating liquid containing the following (d) and (e); and

(v) heat treating the antireflection film, wherein

(a) metal oxide particles having an average primary particle diameter of 10 to 200 nm;

(b) a metal compound;

(c) an ionizing radiation curable resin;

(d) an organosilicon compound represented by Formula (1), a hydrolyzed compound of the organosilicon compound, a decomposed compound of the organosilicon compound or a polycondensed compound of the organosilicon compound,
Si(OR)₄ Formula (1)

wherein R represents an alkyl group; and

(e) hollow silica particles each having an outer shell, and a void or a porous portion in the inside.

(5) The method of Item (4), wherein R represents an alkyl group having 1 to 4 carbon atoms.

(6) The method of Item (4) or Item (5), wherein the heat treatment is carried out after the antireflection film is wound in a roll.

(7) The method of any one of Items (4) to (6), wherein the heat treatment is carried out at a temperature of 50 to 150° C. for a duration of 1 to 30 days.

(8) The method of any one of Items (4) to (7), wherein

the transparent substrate film has a free volume radius determined by positron annihilation lifetime spectroscopy in the range of 0.250 to 0.310 nm.

(9) The method of any one of Items (4) to (8), wherein the step (i) contains the steps of:

(i-1) drying the transparent substrate film until an amount of residual solvent decreases to 0.3% after the transparent substrate film is cast; and

(i-2) treating the transparent substrate film at a temperature of 105 to 155° C. under an atmosphere of not less than 12 times/h of atmosphere replacement rate.

(10) A polarizing plate having the antireflection film of any one of Items (1) to (3) on one surface of a polarizing film and an optical compensation film on the other surface.

(11) A display having the antireflection film of any one of Items (1) to (3).

(12) A display having the polarizing plate of Item (10).

The present invention provides an antireflection film exhibiting improved scratch resistance, pencil hardness, crack resistance, heiz, light resistance and flatness, and a production method thereof as well as to provide a polarizing plate and a display exhibiting an excellent visibility by using the antireflection film.

The best mode to carry out the present invention will now be described in detail, however, the present invention is not limited thereto.

In the present invention, the scratch resistance, pencil hardness, crack resistance, haze, light resistance and flatness of the antireflection film containing hollow silica particles was found to be improved by suitably selecting the material compositions of the specified transparent substrate film, hard coat layer and high refractive index layer, and the heat treatment condition.

The present invention is further described by the following structures.

(13) an antireflection film containing a transparent substrate film having thereon a hard coat film having a layer thickness of 8 to 20 μm, a high refractive index layer having a refractive index higher than a refractive index of the substrate film and a low refractive index layer having a refractive index lower than the refractive index of the substrate film, wherein (i) the high refractive index layer is formed by applying a coating liquid containing the following (a) to (c); (ii) the low refractive index layer is formed by applying a coating liquid containing the following (d) and (e); (iii) the antireflection film is heat treated, wherein (a) metal oxide particles having an average primary particle diameter of 10 to 200 nm; (b) a metal compound; (c) an ionizing radiation curable resin; (d) an organosilicon compound represented by Formula (1), a hydrolyzed compound of the organosilicon compound, a decomposed compound of the organosilicon compound or a polycondensed compound of the organosilicon compound,
Si(OR)₄ Formula (1)
wherein R represents an alkyl group; and (e) hollow silica particles each having an outer shell and a void or a porous portion in the inside.

(14) The antireflection film of Item (13), wherein the transparent substrate film contains a plasticizer and a cellulose ester; and the cellulose ester has a free volume radius determined by positron annihilation lifetime spectroscopy in the range of 0.250 to 0.315 nm.

(15) The antireflection film of Item (13) or Item (14), wherein the cellulose ester has the free volume radius in the range of 0.250 to 0.310 nm.

(16) The antireflection film of any ones of Items (13) to (15), wherein the width of the transparent substrate film is in the range of 1.4 to 4 m.

(17) The antireflection film of any one of Items (13) to (16), wherein the transparent substrate film has a free volume parameter of 1.0 to 2.0.

(18) The antireflection film of any one of Items (13) to (17) wherein the metal oxide particles are selected from the group consisting of zirconium oxide, antimony oxide, tin oxide, zinc oxide, indium-tin oxide (ITO), antimony doped tin oxide (ATO) and zinc antimonate.

(19) The antireflection film of any one of Items (13) to (18), wherein the metal compound is a compound represented by the following Formula (2) or a chelate compound thereof and the content of a metal oxide originated from the metal compound is in the range of 0.3 to 0.5% by weight.
AₙMBₓ₋ₙ Formula (2)
where M represents a metal atom, A represents a functional group which can be hydrolyzed or a hydrocarbon group having a functional group which can be hydrolyzed, B represents a atom group covalently or ionically bonded to M, x represents a valence of metal M and n represents an integer of two or more but not more than x.

(20) The antireflection film of any one of Items (13) to (19), wherein the metal compound is selected from the group consisting of titanium alkoxide, zirconium alkoxide and chelate compounds thereof.

(21) The antireflection film of any one of Items (13) to (20), wherein the ionizing radiation curable resin contains an acryl compound having two or more polymerizable unsaturated bonds in a molecule.

(22) The antireflection film of Item (21), wherein the acryl compound is selected from the group consisting of pentaerythritol multi-functional acrylate, dipentaerythritol multi-functional acrylate, pentaerythritol multi-functional methacrylate, and dipentaerythritol multi-functional methacrylate.

(23) The antireflection film of any one of Items (13) to (22), wherein the weight ratio of a photopolymerization initiator to the acryl compound having two or more polymerizable unsaturated bonds in a molecule contained in the ionizing radiation curable resin is in the range of 3:7-1:9.

(24) The antireflection film of any one of Items (13) to (23), wherein, in the above: (a) metal oxide particles having an average primary particle diameter of 10 to 200 nm; (b) a metal compound; and (c) an ionizing radiation curable resin, the weight ratio of the metal compound of (b) to the ionizing radiation curable resin of (c) is in the rage of 1:3-1:100.

(25) The antireflection film of any one of Items (13) to (24), wherein the hard coat layer, the high refractive index layer and the low refractive index layer further contain (f) a fluorine-containing surfactant, silicone oil or a silicone surfactant.

(26) A method for producing an antireflection film containing the steps of: (i) producing a transparent substrate film; (ii) forming a hard coat layer having a thickness of 8 to 20 μm on the transparent substrate film; (iii) forming a high refractive index layer having a refractive index higher than a refractive index of the substrate film by applying a coating liquid containing the following (a) to (c); (iv) forming a low refractive index layer having a refractive index lower than the refractive index of the substrate film by applying a coating liquid containing the following (d) and (e); and (v) heat treating the antireflection film, wherein (a) metal oxide particles having an average primary particle diameter of 10 to 200 nm; (b) a metal compound; (c) an ionizing radiation curable resin; (d) an organosilicon compound represented by Formula (1), a hydrolyzed compound of the organosilicon compound, a decomposed compound of the organosilicon compound or a polycondensed compound of the organosilicon compound,
Si(OR)₄ Formula (1)
wherein R represents an alkyl group; and (e) hollow silica particles each having an outer shell and a void or a porous portion in the inside.

(27) The method of Item (26), wherein the heat treatment is carried out after the antireflection film is wound in a roll.

(28) The method of Item (26) or Item (27), wherein the heat treatment is carried out at a temperature of 50 to 150° C. for a duration of 1 to 30 days.

(29) The method of any one of Items (26) to (28), wherein the transparent substrate film has a free volume radius determined by positron annihilation lifetime spectroscopy in the range of 0.250 to 0.315 nm.

(30) The method of any one of Items (26) to (29), wherein the free volume radius is in the range of 0.250-0.310 nm.

(31) The method of any one of Items (26) to (30), wherein the step (i) further contains the steps of: (i-1) drying the transparent substrate film until an amount of residual solvent decreases to 0.3% after the transparent substrate film is cast; and (i-2) treating the transparent substrate film at a temperature of 105 to 155° C. under an atmosphere of not less than 12.times/h of atmosphere replacement rate.

(32) A polarizing plate having the antireflection film of any one of Items (13) to (25) on one surface and an optical compensation film on the other surface.

(33) A display having the antireflection film of any one of Items (13) to (25) or the polarizing plate of Item (32).

The present invention will now be more detailed.

(Transparent Substrate Film)

Transparent substrate films usable in the present invention will now be described.

Listed as preferred conditions as the transparent substrate films according to the present invention are: easy production, excellent adhesion to the ionizing radiation curable resin layer, optical isotropy, and optical transparency.

Transparency, as described in the present invention, refers to visible light transmittance of 60 percent or more, preferably 80 percent or more, and most preferably 90 percent or more.

Transparent substrate films are not particularly limited as long as they exhibit the aforesaid properties. Examples include cellulose ester based film, polyester based film, polycarbonate based film, polyallylate based film, polysulfone (including polyestersulfone) based film, polyester film containing polyethylene terephthalate or polyethylene naphthalate, polyethylene film, polypropylene film, cellophane, cellulose diacetate film, cellulose triacetate film, cellulose acetate propionate film, cellulose acetate butyrate film, polyvinylidene chloride film, polyvinyl alcohol film, ethylene vinyl alcohol film, cyndioctatic polystyrene based film, polycarbonate film, cycloolefin polymer film (Arton, manufactured by JSR Co.), Zeonex and Zeonare (both manufactured by Zeon Corp.), polymethylpentane film, polyether ketone film, polyether ketoneimide film, polyamide film, fluorine resin film, nylon film, polymethyl methacrylate film, acryl film, or glass plates. Of these, preferred are cellulose triacetate film, polycarbonate film, and polysulfone (including polyethersulfone) film. In the present invention, from the viewpoint of production, cost, transparency, isotropy, and adhesion property, preferably employed is cellulose ester film (e.g., Konica Minolta Tac, a trade name, KC8UX2MW, KC4UX2MW, KC8UY, KC4UY, KC5UN, KC12UR, KC8UCR-3, KC8UCR-4 and KC8UCR-5 manufactured by Konica Minolta Opto, Inc.). These films may be melt-casting films or solution-casting films.

In the present invention, as a transparent substrate film, cellulose ester based film is preferably used. As cellulose ester, preferably used are cellulose acetate, cellulose acetate butyrate and cellulose acetate propionate, cellulose acetate butyrate film, of these, more preferably used are cellulose acetate butyrate, cellulose acetate naphthalate and cellulose acetate propionate.

Specifically preferable is a laminated low reflection film formed by using a transparent substrate film containing an ester of mixed aliphatic acids and cellulose, having thereon a hard coat layer and an antireflection, provided that the following formulas are satisfied.
2.3≦X+Y≦3.0
0.1≦Y≦1.2
wherein X represents the degree of substitution of an acetyl group, while Y represent the degree of substitution of a propionyl group or a butyryl group.

More specifically, preferred are cellulose esters which satisfy the following formulas:
2.5≦X+Y≦2.9
0.3≦Y≦1.2

In order to obtain an antireflection film exhibiting reduced transformation of the substrate film due to heat treatment and an excellent flatness of the substrate film, the transparent substrate film of the present invention preferably contains a plasticizer and cellulose ester having a free volume radius determined by positron annihilation lifetime spectroscopy in the range of 0.250 to 0.315 nm. Further, the free volume parameter of the cellulose ester film is preferably in the range of 1.0-2.0.

The free volume in the present invention represents vacant area which is not occupied by the cellulose ester chain. This free volume can be measured using positron annihilation lifetime spectroscopy. More specifically, by measuring the time from injection of positrons into a cellulose ester film to the annihilation of the positrons, namely annihilation lifetime of positrons, size and numerical concentration of free volume holes are nondestructively estimated from the annihilation lifetime of positrons.

<Measurement of Free Volume Radius by Positron Annihilation Lifetime Spectroscopy, and Free Volume Parameter>

A positron annihilation lifetime and relative intensity were measured under the following measurement condition.

(Measurement Condition)

Positron source: 22NaCl (intensity: 1.85 MBq)

Gamma-ray detector: Plastic scintillator+Photomultiplier tube

Apparatus time resolution: 290 ps

Measurement temperature: 23° C.

Total number of counts: 1 million counts

Specimen size: 20 mm×15 mm×2 mm 20 pieces of 20 mm x 15 mm sized films were piled to prepare an about 2 mm thick sample. The sample was dried under vacuum 24 hours.

Irradiation area: About 10 mm in diameter

Time per channel: 23.3 ps/ch

According to the above measurement condition, positron annihilation lifetime spectroscopy was carried out. Using a nonlinear least-square method, three components of cellulose ester films were analyzed. When the annihilation times were referred to as, in small order, τ1, τ2 and τ3 and the corresponding intensities were referred to as I₁, I₂ and I₃ (I₁+I₂+I₃=100%), respectively, using the largest annihilation time τ3, a free volume radius R₃ (nm) was determined using the following formula. The larger the τ3 value is, the larger the free volume is estimated to be.
τ3=(½)[1-{R₃/(R₃+0.166)}+(1/2π)sin{2πR₃/(R₃+0.166)}]⁻¹
where, 0.166 (nm)+represents the thickness of the electronic layer which is exuding from the wall of a hole.

The free volume parameter VP was determined by the following formula.
V₃={(4/3)π(R₃)³}(nm³)
VP=I₃(%)×V₃(nm³)

Since I₃ (%) is equivalent to the relative number concentration of a hole, VP is equivalent to the relative amount of holes.

The above measurements were repeated twice and the mean values were calculated for the determination.

Evaluation of a free volume in polymer by positron annihilation spectroscopy is explained in, for example, MATERIAL STAGE vol. 4, No. 5, 2004, pp. 21-25, THE TRC NEWS, No. 80 (July, 2002) PP. 20-22 (published by Toray Research Center), and “BUNSEKI (Analysis)”, 1988, pp. 11-20”.

The free volume radius of the cellulose ester film of the present invention is in the range of 0.250-0.315, preferably 0.250-0.310 nm and more preferably 0.285-0.305 nm. In an industrial process, it may be rather difficult to produce a cellulose ester film having a free volume radius of less than 0.250 nm or a free volume parameter less than 1.0. In the cellulose ester film prepared by the conventional preparation method, which may have a free volume radius of more than 0.315 nm, it seems to be difficult to obtain the effect of the present invention, namely, the transformation of the substrate film due to heat treatment is relatively large and it seems to be relatively difficult to obtain an antireflection film exhibiting excellent flatness. The free volume parameters are preferably in the range of 1.0-2.0, and more preferably in the range of 1.2-1.8. When the free volume parameter is less than 1.8, stability of the cellulose ester film against heat treatment is more improved.

The method to control the free volume radius and the free volume parameter of a cellulose ester film containing a plasticizer and a cellulose ester within the prescribed ranges is not specifically limited, however, they may be controlled by the following method.

A cellulose ester film having a free volume radius of 0.250-0.315, preferably 0.250-0.310 and a free volume parameter of 1.0-2.0 determined by positron annihilation lifetime spectroscopy is obtained by a method containing the steps of:

casting a dope containing a plasticizer and a cellulose ester on a support to form a web;

peeling the web from the support;

stretching the web while the web still contains a solvent;

further drying the web until an amount of residual solvent decreases to 0.3%; and

heat treating the web at 105-155° C. under a rate of atmosphere replacement of 12 times/h or more or more preferably 12-45 times/h while the web is transported.

The rate of atmosphere replacement is the number of times replacing the atmosphere of a heat treatment chamber by fresh-air per unit time determined by the following equation, provided that the volume of the heat treatment chamber is expressed as V (m³) and the amount of fresh-air sent to the heat treatment chamber is expressed as FA (m³/h). Fresh-air does not include the air which is recycled and circulating among the air sent to the heat treatment chamber but includes the air containing no evaporated solvent nor evaporated plasticizer, or the air from which evaporated solvent or evaporated plasticizer are removed.

Rate of atmosphere replacement=FA/V (times/h) When the heat treatment temperature exceeds 155° C., or when it is lower than 105° C., the effect of the present invention tends not be acquired.

As the operating temperature, it is still more preferable that the operating temperature is in the range of 110-150° C. Further, preferable is that the heat treatment is carried out under the condition in which the rate of atmosphere replacement is 12 times/h or more to obtain a transparent substrate film preferably used in the present invention.

When the rate of atmosphere replacement is 12 times/h or more, the concentration of the plasticizer evaporated from the cellulose ester film in the atmosphere is thoroughly reduced, accordingly, re-deposition of the plasticizer to the cellulose ester film is also reduced. This is assumed to contribute in attaining the effect of the present invention. In the ordinary drying process, the rate of atmosphere replacement has been not more than 10 times/h. When the rate of atmosphere replacement is increased more than necessary, the production cost increases and due to the fluttering of the web, unevenness in property of cellulose ester increases. Accordingly, it is not recommended that the rate of atmosphere replacement is increased more than necessary, however, after the web was thoroughly dried and the amount of residual solvent is considerably decreased, it can be increased. However, the rate of atmosphere replacement of 45 times/h or more is not practical since the production cost drastically increases. The heat treatment under the rate of atmosphere replacement of 12 times/h or more is preferably carries out within 1 minute-1 hour. If the treatment time is less than 1 minute, the free volume radius within a prescribed range may not be obtained, while, when it is not more than 1 hour, a preferable effect of this treatment is obtained.

Further, in this process, a pressurizing treatment of the cellulose ester film in the thickness direction may also be effectively carried out to control the free energy volume radius and the free volume parameter within more preferable ranges. The pressure is preferably 0.5-10 kPa. The amount of residual solvent at the stage when the pressurizing treatment is carried out is preferably less than 0.3%.

In the conventional cellulose ester film which has not been subjected to the above mentioned treatments, the free volume radius has been larger than 0.315 nm.

Cellulose as a source material of the cellulose ester of the present invention is not specifically limited, however, usable are cotton linter, wood pulp (obtained from acicular trees or from broad leaf trees) or kenaf. The cellulose esters obtained from these cellulose source materials may also be used by mixing with each other in any ratio. In case, an acid anhydride (acetic anhydride, propionic anhydride, and butyric anhydride) is used as an acylation agent, cellulose ester can be prepared through a common reaction using an organic acid such as acetic acid and an organic solvent such as methylene chloride, in the presence of a protic catalyst such as sulfuric acid.

When an acylation agent is an acid chloride (CH₃COCl, C₂H₅COCl or C₃H₇COCl), a reaction is carried out using a basic compound such as an amine as a catalyst. Specifically, the reaction can be carried out according to the method disclosed in JP-A No. 10-45804. The cellulose ester used in the present invention is obtained through a reaction using in combination of the above acylation agents depending on the acylation degree. In an acylation reaction to form a cellulose ester, an acyl group reacts with the hydroxyl group of a cellulose molecule. A cellulose molecule is made up of many glucose units connected each other, and a glucose unit contains three hydroxyl groups. The number of hydroxyl groups substituted by acyl groups in a glucose unit is referred to as a degree of acetyl substitution. For example, in the case of cellulose triacetate, all the three hydroxyl groups in one glucose unit are substituted by acetyl groups (practically: 2.6-3.0).

The cellulose ester used for the present invention is not specifically limited, however, preferably employed are mixed fatty acid esters of cellulose in which a propionate group or a butyrate group is bonded to cellulose in addition to an acetyl group, for example, cellulose acetate propionate, cellulose acetate butyrate or cellulose acetate propionate butyrate. The butyryl group which forms butyrate may be linear or branched.

Cellulose acetate propionate which contains a propionate group as a substituent is excellent in water resistance, and useful as a film for a liquid crystal display.

The acylation degree of cellulose is determined according to a method of ASTM-D 817-96.

The number average molecular weight of the cellulose ester of the present invention is preferably 70000-250000 in order to obtain a sufficient mechanical strength of the film and to obtain moderate viscosity of the dope, and it is more preferably 80000-150000.

The cellulose ester film is preferably produced by a generally called “solution casting method” which includes casting a solution of dissolved cellulose ester (also referred to as a dope) from a pressure die onto a casting support, for example, an endless metal belt which is endlessly running or a rotating to form a film.

The organic solvent preferably used for preparing a dope includes the one which dissolves cellulose ester and has a moderate boiling point, examples of which include: methylene chloride, methyl acetate, ethylacetate, amyl acetate, methyl acetoacetate, acetone, tetrahydrofuran, 1,3-dioxolane, 1,4-dioxane, cyclohexanone, ethyl formate, 2,2,2-trifluoro ethanol, 2,2,3,3-tetra-fluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane, 1,3-dimethyl-2-imidazolidinone. Of these, examples of a preferable organic solvents (namely, a good solvent9 include: organic halogenated solvents, such as methylene chloride, a dioxolane derivative, methyl acetate, ethyl acetate, acetone, methyl acetoacetate.

The boiling point of the organic solvent used in the present invention is preferably 30-80° C., in order to avoid foaming of the organic solvent in the web in the solvent evaporation process of the web which will be described below in the film forming process, the web being a film of the dope formed by casting the dope on a casting support. Examples of boiling points of the above described good solvents are as follows: methylene chloride (boiling point: 40.4° C.), methyl acetate (boiling point: 56.32° C.), acetone (boiling point: 56.3° C.) and ethylacetate (boiling point: 76.82° C.).

Among the above described good solvents, specifically preferable are methylene chloride or methyl acetate which is excellent in solubility of cellulose ester.

An alcohol having 1-4 carbon atoms of the content of 0.1-40% by weight is preferably contained in the above described organic solvent. The content is more preferably 5-30% by weight. When alcohol is contained in a web, after casting a dope on a support and the solvent being partially evaporated from the web, the relative concentration of alcohol becomes higher and the web begins to gelate. The gelation increases the mechanical strength of the web and makes it easier to peel the web from the support. A smaller concentration of alcohol in a dope may contribute to increase a solubility of cellulose ester in a non-chlorine based organic solvent

Examples of an alcohol having a carbon number of 1 to 4 include: methanol, ethanol, n-propanol, iso-propanol, n-butanol, sec-butanol and tert-butanol.

Among these alcohols, ethanol is specifically preferable, because ethanol is stable, having a low boiling point, being easy to evaporate and non-toxic. It is preferable to use the solvent which contains 5-30% by, weight of ethanol and 70-95 wt % of methylene chloride. Methyl acetate can also be used instead of methylene chloride. In this case, the dope solution may be prepared via a cooling solution process.

When using a cellulose ester film for the antireflection film of the present invention, it is preferable to contain at least one of the following plasticizers. Examples of a preferably usable plasticizer include: a phosphate plasticizer, a polyalcohol ester plasticizer, a phthalate plasticizer, a trimellitate plasticizer, a pyromellitate plasticizer, a glycolate plasticizer, a citrate plasticizer, a polyester plasticizer, a fatty acid ester plasticizer, a polycarboxylic acid ester plasticizer.

Of these, more preferable are a polyalcohol ester plasticizer, a phthalate plasticizer, a citrate plasticizer, a fatty acid ester plasticizer, a glycolate plasticizer and a polycarboxylic acid ester plasticizer. Specifically, a polyalcohol ester plasticizer is preferable, whereby pencil hardness of the hard coat layer of 4H or more is stably obtained.

A polyalcohol ester plasticizer is a plasticizer containing an ester of an aliphatic polyalcohol having a valence of two or more and a monocarboxylic acid, and it preferably contains an aromatic ring or a cycloalkyl ring in the molecule. It is preferably an aliphatic polyalcohol ester having a valence of 2-20.

The polyalcohol used for the present invention is represented with the following Formula (I).
R₁—(OH)n Formula (I)
wherein, R₁ represents-an organic group having a valence of n, n represents a positive integer of two or more, and an OH group represents an alcoholic or a phenolic hydroxyl group.

Examples of preferable polyalcohol include: adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-bunanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol, but the invention is not limited thereto. Specifically, triethylene glycol, tetraethylene glycol, dipropylene glycol, tripropylene glycol, sorbitol, trimethylol propane and xylitol are preferable.

As the monocarboxylic acid to be used in the polyalcohol ester, a known aliphatic monocarboxylic acid, alicyclic monocarboxylic acid and aromatic monocarboxylic acid may be employed, though the monocarboxylic acid is not specifically limited. Specifically, aliphatic monocarboxylic acid and aromatic monocarboxylic acid are preferable, because the moisture permeability and the volatility are reduced.

Examples of the preferable monocarboxylic acid are listed below but the present invention is not limited thereto.

A straight or branched chain carboxylic acid having 1 to 32 carbon atoms is preferably employed. The number of carbon atoms is more preferably 1-20, and specifically preferably 1-10. The addition of acetic acid is preferable for raising the compatibility with a cellulose ester, and the mixing of acetic acid with another carboxylic acid is also preferable.

As the preferable aliphatic monocarboxylic acid, saturated fatty acids such as acetic acid, propionic acid, butylic acid, valeric acid, caproic acid, enantic acid, caprylic acid, pelargonic acid, capric acid, 2-ethyl-hexane acid, undecylic acid, lauric acid, tridecylic acid, myristic acid, pentadecylic acid, palmitic acid, heptadecylic acid, stearic acid, nonadecanic acid, arachic acid, behenic acid, lignocelic acid, cerotic acid, heptacosanic acid, montanic acid, melisic acid and lacceric acid; and unsaturated fatty acids such as undecylenic acid, oleic acid, sorbic acid, linolic acid, linolenic acid and arachidonic acid can be exemplified.

Examples of preferable alicyclic carboxylic acid include cyclopentane carboxylic acid, cyclohexane carboxylic acid, cyclooctane carboxylic acid and derivatives thereof.

Examples of preferable aromatic carboxylic acid include ones formed by introducing an alkyl group into the benzene ring of benzoic acid such as benzoic acid and toluic acid; and an aromatic monocarboxylic acid having two or more benzene rings such as biphenylcarboxylic acid, naphthalene carboxylic acid and tetralin carboxylic acid, and derivatives thereof, of these, benzoic acid is specifically preferable.

The molecular weight of the polyalcohol ester is preferably from 300 to 1,500,. and more preferably from 350 to 750, though the molecular weight is not specifically limited. Larger molecular weight is preferable for storage ability, while smaller molecular weight is preferable for compatibility with cellulose ester.

The carboxylic acid to be employed in the polyalcohol ester may be one kind or a mixture of two or more kinds of them. The OH groups in the polyalcohol may be fully esterified or a part of OH groups may be left unreacted.

Concrete examples of the polyalcohol ester are listed below.

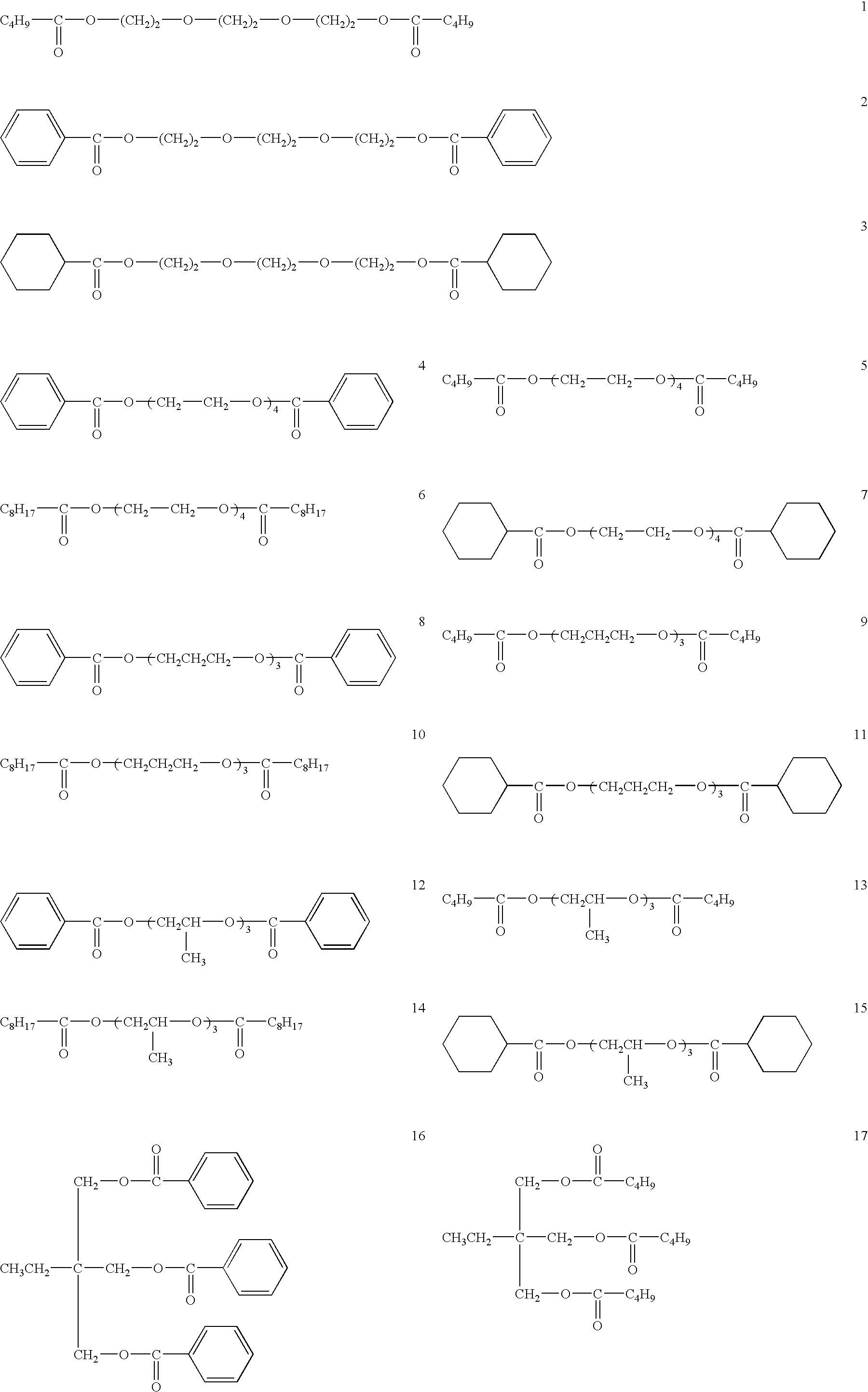

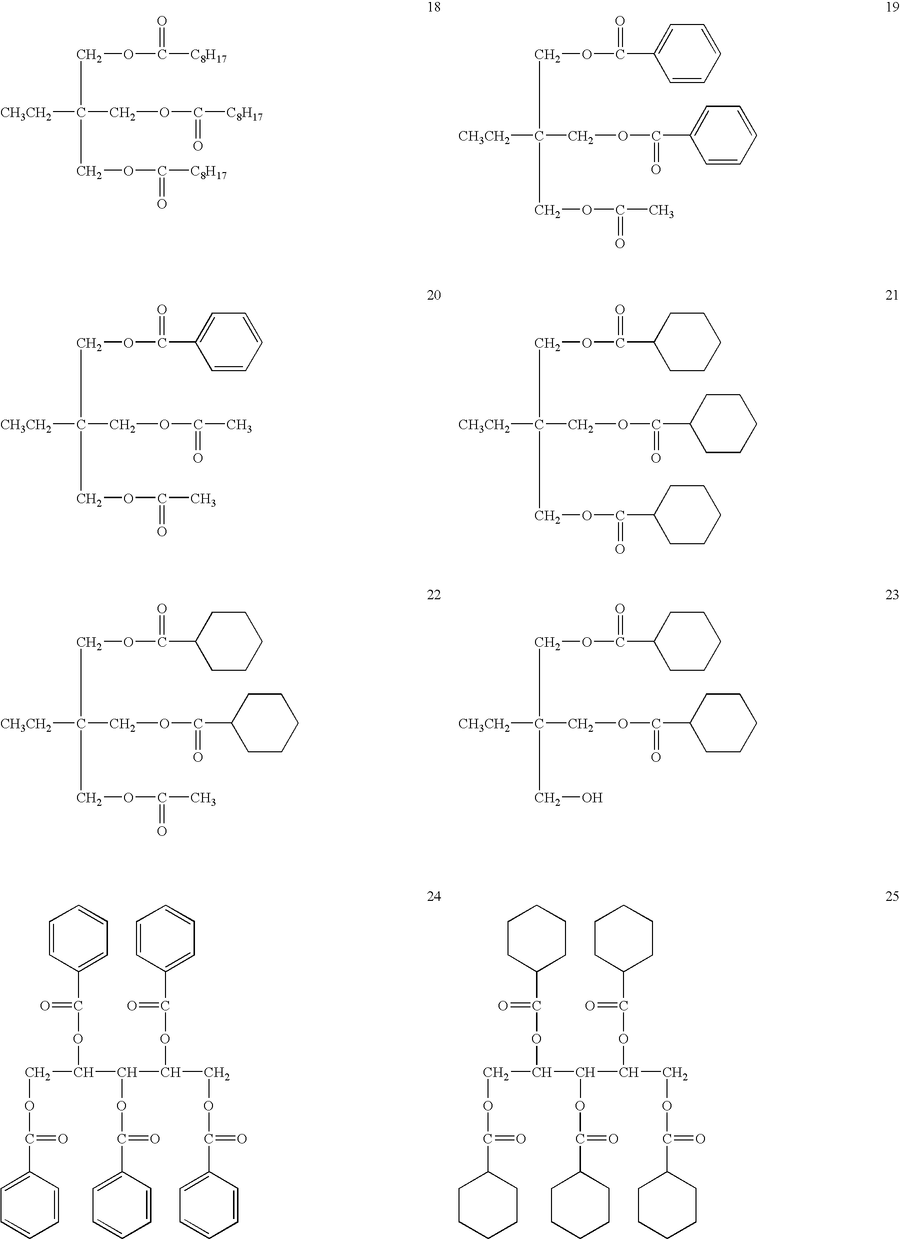

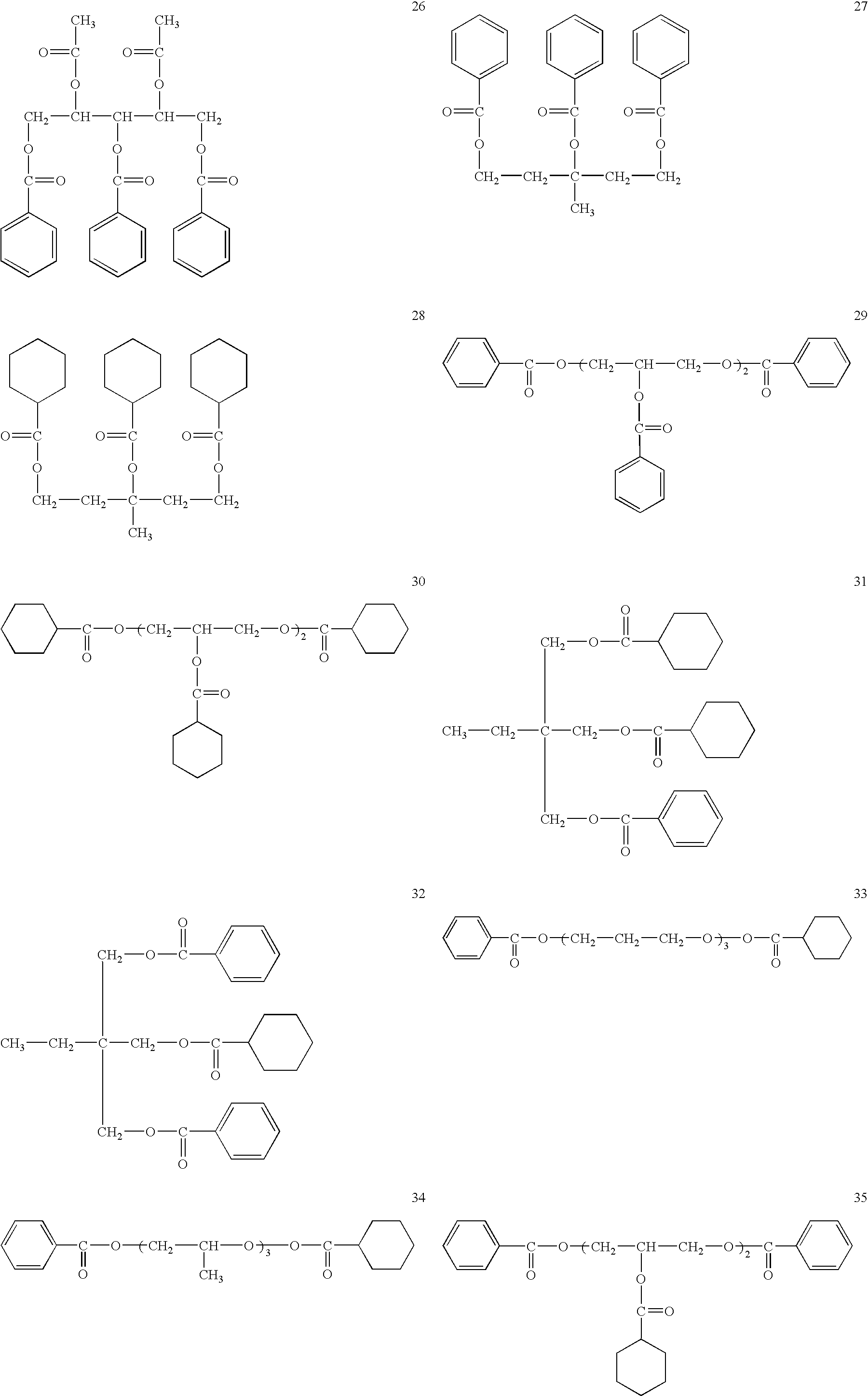

As for a glycolate plasticizer, alkylphthalylalkyl glycolates are preferably used. Examples of an alkylphthalylalkyl glycolate include: methylphthalylmethyl glycolate, ethylphthalylethyl glycolate, propylphthalylpropyI glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate and octylphthalylethyl glycolate.

Examples of a phthalate plasticizer include: diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate and dicyclohexyl terephthalate.

Examples of a citrate plasticizer include: acetyltrimethyl citrate, acetyltriethyl citrate and acetyltributyl citrate.

Examples of a fatty acid ester plasticizer include: butyl oleate, methylacetyl ricinoleate and dibutyl sebacate.

A polycarboxylate plasticizer is also used preferably. It is preferable to add one of polycarboxylates disclosed in JP-A No. 2002-265639, paragraph number [0015]-[0020] as one of the plasticizers.

Examples of a phosphate plasticizer include: triphenyl phosphate, tricresyl phosphate, cresyl diphenyl phosphate, octyl diphenyl phosphate, diphenyl biphenyl phosphate, trioctyl phosphate and tributyl phosphate.

The total content of the plasticizer in a cellulose ester film is preferably 5-200% by weight, more preferably 6-16% by weight and specifically more preferably 8-13% by weight, based on the total solid weight of the cellulose ester film. When two kinds of plasticizers are used, the content of each plasticizer is preferably at least 1% by weight, and more preferably each content is not less than 2% by weight.

The content of polyalcohol ester plasticizer is preferably 1-12% by weight-and more preferably 3-11% by weight. When the content is too low, deterioration in flatness may occur and when it is too high, bleeding-out tends to occur. The weight ratio of the polyalcohol ester plasticizer to other plasticizer is preferably 1:4-4:1 and more preferably 1:3-3:1. Too high or too low content of the plasticizer tends to result in deformation of the film The antireflection film of the present invention preferably contains a UV absorbing agent.

Preferably usable is a UV absorbing agent having a high absorbance for UV rays of wavelength of 370 nm or less while having a high transmittance for visible light of wavelength of 400 nm or more in order to give a favorable displaying property of a liquid crystal display.

Examples of a UV absorbing agent preferably used in the present invention include: an oxybenzophenone based compound, a benzotriazol based compound, a salicylic acid ester based compound, a benzophenone based compound, a cyanoacrylate based compound, a triazinebased compound and a nickel complex salt.

Examples of benzotriazol based UV absorbing agent-will be given below, however, the present invention is not limited thereto.

UV-1: 2-(2′-hydroxy-5′-methylphenyl) benzotriazole

UV-2: 2-(2′-hydroxy-3′,5′-di-tert-butylphenyl) benzotriazole

UV-3: 2-(2′-hydroxy-3′-tert-butyl-5′-methylphenyl) benzotriazole

UV-4: 2-(2′-hydroxy-3′,5′-di-tert-butylphenyl)-5-chloro benzotriazole

UV-5: 2-(2′-hydroxy-3′-(3″,4″,5″,6″-tetrahydro phthalimidomethyl)-5′-methylphenyl) benzotriazole

UV-6: 2,2-methylenebis (4-(1,1,3,3-tetramethylbutyl)-6-(2H-benzotriazole-2-yl) phenol)

UV-7: 2-(2′-hydroxy-3′-tert-butyl-5′-methylphenyl)-5-chlorobenzotriazole

UV-8: 2-(2H-benzotriazole-2-yl)-6-(n- and iso-dodecyl)-4-methylphenol (TINUVIN171, product of Ciba Specialty Chemicals Inc.)

UV-9: Mixture of octyl-3-[3-tert-butyl-4-hydroxy-5-(chloro-2H-benzotriazole-2-yl) phenyl] propionate and 2-ethylhexyl-3-[3-tert-butyl-4-hydroxy-5-(5-chloro-2H-benzotriazole-2-yl) phenyl] propionate (TINUVIN109, product of Ciba Specialty Chemicals Inc.)

Specific examples of a benzophenone based compound are shown below, however, the present invention is not limited thereto.

UV-10: 2, 4-dihydroxy benzophenone

UV-11: 2,2′-dihydroxy-4-methoxybenzophenone

UV-12: 2-hydroxy-4-methoxy-5-sulfobenzophenone

UV-13: Bis (2-methoxy-4-hydroxy-5-benzoylphenyl methane)

As UV absorbing agent preferably used in the present invention, the benzotriazole or benzophenone type UV absorbing agent is preferably used which has high transparency, and minimizes deterioration of a polarizing plate or a liquid crystal. The benzotriazole type UV absorbing agent is especially preferably used, since it minimizes undesired coloration.

The UV absorbing agent disclosed in JP-A No. 2001-187825 having a distribution coefficient of 9.2 or more provide an improved surface quality of a long roll film and a favorable coating property. Preferable is a TV absorbing agent having a distribution coefficient of 1.0 or more.

A polymer UV absorbing agent (or a UV absorbing polymer) disclosed in Formula (1) or (2) in JP-A No. 6-148430 or Formula (3), (6) or (7) in JP-A No. 2000-156039 is also preferably employable. As a commercially available UV absorbing agent, PUVA-30M (produced by OTSUKA Chemical Co., Ltd.) is cited.

In order to provide a lubricating property to the cellulose ester film of the present invention, usable are the particles which will be described below to be used for a coating layer containing an ionizing radiation curable resin.

<Particles>

The cellulose ester film of the present invention preferably contains particles.

As for the particles use in the present invention, examples of inorganic particles include: silicon dioxide particles, titanium dioxide particles, aluminium oxide particles, zirconium oxide particles, calcium carbonate particles, talc particles, clay particles, calcinated caolin particles, calcinated calcium silicate particles, hydration calcium silicate particles, aluminium silicate particles, magnesium silicate particles, and calcium phosphate particles. Particles containing silicon are preferable, because low turbidity of the film is obtained. Silicon dioxide particles are specifically preferable.

The mean diameter of primary particles is preferably from 5 to 50 nm, and more preferably from 7 to 20 nm. The particle preferably exist as an aggregated secondary particle of a diameter from 0.05 to 0.3 μm. The content of the particle in a cellulose ester film is preferably from 0.05 to 1 percent by weight, and is more preferably from 0.1 to 0.5 percent. In a multi-layered cellulose ester film prepared by a co-casting method, a major part of the particles of this amount preferably exist near the surface.

Particles of silicon dioxide available on the market include, for example: AEROSIL R972, R972V, R974, R812, 200, 200V, 300, R202, OX50 and TT600 which are manufacture by Nippon Aerosil Co., Ltd.

Particles of zirconium oxide available on the market include, for example: AEROSIL R976 and R811 manufacture by Nippon Aerosil Co., Ltd.

Particles of polymer available on the market include, for example: silicone resin, fluorine-contained resin and acryl resin. Among these, silicone resin, especially three dimensionally networked silicone resin is preferably used. Examples of silicone resins include: TOSPERL 103, 105, 108, 120, 145, 3120 and 240, which are manufactured by Toshiba Silicone Co., Ltd.

Among the particles listed above, AEROSIL 200V and AEROSIL R972V are specifically preferable with respect to exhibiting a lower friction coefficient while low turbidity is maintained. Kinetic friction coefficient of the rear side of the hard coat layer of the present invention is preferably not more than 1.0.

<Manufacturing Method of Cellulose Ester Film>

The manufacturing method of the cellulose ester film of the present invention will now be explained.

The manufacturing method of the cellulose ester film of the present invention contains the processes of (i) a dope preparing process in which cellulose ester and an additive, for example, above mentioned plasticizer, are dissolved in a solvent, (ii) a casting process in which a dope is cast on a belt-like or a drum-like metal support, (iii) a drying process in which a cast dope is dried to form a web, (iv) a peeling process in which a dried web is peeled from the metal support, (v) a stretching process or a width keeping process, (vi) a further drying process, (Vii) a winding process of the produced cellulose ester film.

The dope preparation process will now be explained. In the dope preparation process, a higher content of cellulose ester in the dope is preferable since the energy for drying after the dope is cast can be reduced, however, a too high content may result in loss of filtration accuracy. Preferable content of cellulose ester is 10-35% by weight and more preferably 15-25% by weight.

A solvent may be used alone, however, two or more solvents may also be used together. A mixture of a good solvent and a poor solvent is more preferably used to increase manufacturing efficiency. A mixed solvent being rich in a good solvent is preferable to increase solubility of cellulose ester. The preferable mixing ratios are from 70 to 98 percent by weight of a good solvent, and from 2 to 30 percent of a poor solvent. Herein, a good solvent is described as being capable of dissolving cellulose ester with a single use, and a poor solvent as being incapable of dissolving nor swelling cellulose ester alone. Sometimes, a solvent works as a good solvent of a cellulose ester, and sometimes as a poor solvent depending on the acylation degree (degree of acyl substitution) of the cellulose ester. For example, acetone is a good solvent for an acetic ester of cellulose of which the acetylation degree is 2.4, as well as for cellulose acetatepropionate, however, it is a poor solvent for cellulose acetate of which acetylation degree is 2.8.

Example of good solvents used in the present invention include: an organic halide (such as methylene chloride), dioxolane, acetone, methyl acetate and methyl acetoacetate, of these, methylene chloride and methyl acetate are specifically preferable. However, the present invention is not specifically limited thereto.

Examples of poor solvents used in the present invention include: methanol, ethanol, n-butanol, cyclohexane and cyclohexanone, however, the present invention is not specifically limited thereto. A dope may preferably contain from 0.01 to 2 percent by weight of water.

In the process of preparing a dope, cellulose ester is dissolved using a common method. When a solvent is heated under a higher pressure, the solvent can be heated to a temperature higher than its boiling point under a normal pressure. By dissolving cellulose ester while stirring at a temperature higher than the boiling point of the solvent under a normal pressure while applying a higher pressure, formation of gel or an insoluble agglomerate (known as “Mamako” in Japanese which represents insoluble residue when powder is dissolved in a solvent) may be avoided, where the temperature should be lower than the temperature at which the solvent boils even under the higher pressure. The following dissolving method is also preferable, in which cellulose ester is swollen in a poor solvents followed by adding good solvents to dissolve the swollen cellulose ester.

A higher pressure may be applied by injecting an inert gas such as nitrogen or by increasing the vapor pressure of the solvents by heating. Heating is preferably carried out from the outside of the container. A jacket type heater is preferable because the temperature is easily controlled.

A higher dissolving temperature is preferable with respect to the solubility of the cellulose ester, however, too high a temperature may lower the productivity because the pressure also becomes very high. The dissolving temperature is preferably 45-120° C., more preferably 60-110° C. and still more preferably 70-105° C. The pressure is controlled not to allow boiling at the set temperature.

A low temperature dissolution method is also preferably utilized, by which cellulose ester is successfully dissolved in solvents such as methyl acetate.

In the next process, the cellulose ester solution thus prepared is filtered using an appropriate filter material. A filter material with a smaller absolute filtration rating is more preferable for removing insoluble materials, however, too small a filtration rating easily cause clogging up of the filter. The absolute filtration rating of the filter is preferably not larger than 0.008 mm, more preferably 0.001-0.008 mm and still more preferably 0.003-0.006 mm.

The filter material used in the present invention is not specifically limited, and plastic filters (such as polypropylene and Teflon(R)) as well as metal(alloy) filters (such as stainless steel) are preferable, since these materials are free from peeling of a fiber, which may occur when fibrous material is used. Impurities and, specifically, luminescent foreign materials contained in the cellulose ester are preferably diminished or entirely removed by filtering.

“Luminescent foreign materials” denote impurities which are observed as bright spots when a cellulose ester film is placed between two polarizing plates arranged in a crossed Nicols state, illuminated with light from one side and observed from the other side. The number of luminescent foreign materials of larger than 0.01 mm in diameter is preferably less than 200 per cm², more preferably less than 100 per cm², still more preferably less than 50 per cm² and specifically more preferably from 0 to 10 per cm². The number of luminescent-foreign materials of less than 0.01 mm in diameter is preferably minimal.

The dope may be filtered by any common method. One of these preferable filtering methods is to filter the dope at a temperature which is higher than the ambient pressure boiling point of the mixed solvents, and simultaneously in the range where the mixed solvents do not boil under a higher pressure. This method is preferable because the pressure difference between before and after filtering is reduced. The filtering temperature is preferably from 45 to 120° C., more preferably from 45 to 70° C. and still more preferably from 45 to 55° C.

The pressure applied during filtering is preferably low, being preferably 1.6 Mpa or less, more preferably 1.2 Mpa ore less and still more preferably 1.0 Mpa or less.

Casting of a dope will be explained below:

A metal support polished to a mirror finished surface is preferably used in the casting process. A stainless steel belt or a plated cast drum is preferably used as a metal support. The width of the support is preferably from 1 to 4 m. The surface temperature of the metal support is preferably from −50° C. to a temperature just below the boiling point of the solvent. A relatively high temperature of the support is more preferable because the web is more quickly dried, however, too high a temperature may cause foaming or loss of flatness of the web. The temperature of the support is appropriately determined in the range of 0-100° C., however, preferably 5-30° C. Another preferable method is that a web is gelated by cooling the drum followed by peeling the web from the drum while the web still contains much solvent. The method to control the temperature of the support is not specifically limited and a method of blowing warm or cool air onto the support or to apply warm water on the rear side of the support is usable. The warm water method is more preferable because the temperature of the metal support becomes stable in a shorter time due to more efficient thermal conduction. In the case when warm air is used, considering the lowering of the web temperature due to latent heat of evaporation, the air temperature is set higher than the desired temperature of the support while avoiding foaming of the web. Drying process of the web is preferably carried out effectively by changing the temperatures of the warm air and the support during the process between casting and peeling.

In order to obtain a cellulose ester film with a sufficient flatness, the residual solvent content of the web when it is peeled from the metal support is preferably 10-150% by weight, however, more preferably 20-40% by weight or 60-130% by weight. The residual solvent content is specifically more preferably 20-30% by weight or 60-130% by weight.

The residual solvent content of the web is defined by the following formula:
Residual solvent content (% by weight)={(M−N)/N}×100
where M represents the weight of a sample of the web collected in the manufacturing process or after manufacturing, and N represents the weight of the same sample after it was dried at 115° C. for 1 hour.

In the drying process of the cellulose ester film, the film is peeled from the support and further dried until the residual solvent decreases to 1% by weight or less, more preferably 0.1% by weight or less, and specifically more preferably 0-0.1% by weight.

The peeled web is generally dried by a roll drying method (the web is passed through many rolls alternately provided up and down in a staggered array), or by a tenter method in which both edges of the web are clipped while the web is being transported.

In order to produce a cellulose ester film to be used for the antireflection film of the present invention, it is specifically preferable that the peeled web is stretched in the film transportation direction while the web still contains much residual solvent, followed by stretching the web in the lateral direction by holding both edges of the web using pins or clips in the tenter process. The stretching ratios of the web in both the transportation direction and the lateral direction are preferably 1.05-1.3 and more preferably 1.05-1.15. The enlarging ratio of the area of the web after stretching (or shrinking) in the lateral direction and in the film transportation direction is preferably 1.12-1.44 and more preferably 1.15-1.32. The enlarging ratio of the area of the web is obtained by (stretching ratio in the lateral direction)×(stretching ratio in the film transportation direction). When at least one of the stretching ratios in the transportation direction and in the lateral direction is 1.05 or less, degradation in flatness which may occur in the UV irradiation process when the hard coat layer is formed becomes more easily to occur.

In order to stretch the cellulose ester film in the transportation direction just after peeled from the support, the stretching is preferably carried out by a peeling tension or by a transporting tension. For example, the peeling tension is preferably 210 N/m or more and specifically preferably 220-300 N/m.

The method to dry the web is not specifically limited, however, generally, hot air, IR ray, heated rollers or microwave irradiation is used. Hot air is preferably used with respect to ease of cure.

The preferable drying temperature of a web is 30 to 150° C. and the temperature is preferably increased stepwise. The temperature is more preferably 40 to 140° C. to obtain stable film dimensions.

The thickness of a cellulose ester is not specifically limited, however, a thickness of 10 to 200 μm is preferable. So far, when the thickness of a cellulose ester film is 10 to 70 μm, it has been relatively difficult to obtain a film exhibiting a sufficient flatness as well as a sufficient scratch resistance, however, in the present invention, a thin antireflection film exhibiting a sufficient flatness and a sufficient scratch resistance can be obtained at considerably high productivity. Hence, a preferable film thickness is 10 to 70 μm, more preferably from 20 to 60 μm and most preferably from 35 to 6.0 μm. Further, a multilayered cellulose ester film is preferably produced by a co-casting method. Also in a multilayered cellulose ester film, layers containing a UV absorbing agent and a plasticizer are contained, which may be a core layer, skin layer or both of them.

The width of the antireflection film of the present invention is preferably from 1.4 to 4 m. The center line average roughness (Ra) of the surface of the cellulose ester film on which an ionizing radiation curable resin layer is formed can be 0.001 to 1 μm in the present invention.

So far, there has been a problem for a wide cellulose ester film in that unevenness in irradiation of UV rays becomes notable and degradation in flatness and uniformity in hardness cannot be ignored. Accordingly, when an antireflection layer is formed on such a cellulose ester film, unevenness in reflectivity also becomes notable. However, in the present invention, an antireflection film can be formed with a smaller amount of UV ray irradiation, accordingly, the unevenness in UV ray irradiation in the lateral direction of the film tends not to cause unevenness in hardness or serious loss of flatness. Consequently, the effect of the present invention is notable for a wider cellulose ester film. A cellulose ester film with a width of 1.4-4 m is preferably used and that of 1.4-3 m is specifically preferable. A film with a width of more than 4.0 m cause problems in transportation.

The production method of an antireflection film of the present invention using the above described cellulose ester film as the substrate film will now be explained in detail.

<Hard Coat Layer>

The antireflection film of the present invention contains a hard coat layer of the thickness of 8-20 μm. The hard coat layer is applied using a coating method as described below, for example, a gravure coater, or a die coater. The dry thickness is preferably 8-20 μm and more preferably 10-16 μm. When the thickness is less than 8 μm, sufficient scratch resistance may not be obtained, and when it exceeds 20 μm, the flatness may be degraded. The variation of thickness in the transportation direction of the long roll film is preferably ±0.5 μm or less based on the average film thickness, more preferably ±0.1 μm or less, still more preferably ±0.05 μm or less, and specifically more preferably ±0.01 μm or less.

The hard coat layer of the present invention is preferably an ionizing radiation curable resin layer.

An ionizing radiation curable resin layer refers to a layer mainly containing a resin which can be cured through a cross-linking reaction caused by irradiating with ionizing radiation such as UV rays or electron beams. A composition containing ethylenically unsaturated monomers is preferably utilized to form a hard coat layer by hardening the composition with irradiating ionizing radiation such as UV rays or electron beams. Typical examples of ionizing radiation curable resin include a UV ray-curable resin and an electron beam curable resin, however, a UV ray-curable resin is more preferably utilized.

The UV curable resin includes, for example: a UV-curable urethane acrylate resin, a UV-curable polyester acrylate resin, a UV-curable epoxy acrylate resin, a UV-curable polyol acrylate resin and a UV-curable epoxy resin. Of these, preferable is a UV-curable polyol acrylate resin.

The UV-curable urethane acrylate resin includes compounds which are generally prepared easily by, initially, reacting polyester polyol with a monomer or a prepolymer of isocyanate, followed by further reacting the product with an acrylate monomer having a hydroxy group such as 2-hydroxyethyl acrylate, 2-hydroxyethyl methacrylate (herinafter, only acrylates are described, however methacrylates are also included) and 2-hydroxypropyl acrylate. For example, a compound disclosed in JP-A 59-151110 is preferably used.

For example, a mixture of 100 weight parts of UNIDIC 17-806 (Dainippon Ink and Chemicals, Inc.) and 1 weight part of COLONATE L (Nippon Polyurethane Industry Co., Ltd.) is preferably used.

The UV-curable polyester acrylate resins include compounds which are generally prepared easily by reacting a polyester polyol with a 2-hydroxyethyl acrylate monomer or a 2-hydroxy acrylate monomer. For example, those disclosed in JP-A 59-151112 are preferably used.

The UV-curable epoxy acrylate resin includes compounds which are prepared by reacting an epoxy acrylate oligomer with a reactive dilutant and a photoreaction initiator. For example, as disclosed in JP-A 1-105738 are preferably used.

The UV-curable polyol acrylate type resin includes, for example: trimethylol propane triacrylate, ditrimethylol propane tetracrylate, pentaerythritol triacrylate, pentaerythritol tetracrylate, dipentaerythritol hexaacrylate and alkyl modified dipentaerythritol pentaacrylate.

The photopolymerization initiators include, for example: benzoine including derivatives, acetophenone, benzophenone, hydroxy benzophenone, Michler's ketone, α-amyloxim ester, thioxanthone and derivatives thereof. These compounds may be utilized together with a photo sensitizer. The photopolymerization initiator described above can also be utilized as a photo sensitizer. Further, sensitizers such as n-butyl amine, triethyl amine and tri-n-butyl phosphine can be utilized together with an epoxy acrylate photopolymerization agent. The amount of a photopolymerization initiator or a photo sensitizer is preferably from 0.1 to 15 weight parts, more preferably from 1 to 10 weight parts in 100 weight parts of the UV-curable resins described above.

Resin monomers include, for example: (i) a monomer having one unsaturated double bond, such as methyl acrylate, ethyl acrylate, isopropyl acrylate, butyl acrylate, benzyl acrylate, cyclohexyl acrylate, vinyl acetate and styrene, and (ii) a monomer having two or more unsaturated double bonds, such as ethyleneglycol diacrylate, propyleneglycol diacrylate, divinyl benzene, 1,4-cyclohexyane diacrylate and 1,4-cyclohexyldimethyl diacrylate. Foregoing trimethylolpropane triacrylate and pentaerythritol tetraacrylate ester are also included.

Selected products available on the market as a UV curable resin which can be utilized in the present invention may be: Adekaoptomer KR, BY Series such as KR-400, KR-410, KR-550, KR-566, KR-567 and BY-320B (manufactured by Asahi Denka Co., Ltd.); Koeihard A-101-KK, A-101-WS, C-302, C-401-N, C-501, M-101, M-102, T-102, D-102, NS-101, FT-102Q8, MAG-1-P20, AG-106 and M-101-C (manufactured by Koei Kagaku Co., Ltd.); Seikabeam PHC2210(S), PHC X-9(K-3), PHC2213, DP-10, DP-20, DP-30, P1000, P1100, P1200, P1300, P1400, P1500, P1600, SCR900 (manufactured by Dainichiseika Kogyo Co., Ltd.); KRM7033, KRM7039, KRM7130, KRM7131, UVECRYL29201 and UVECRYL29202 (manufactured by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (manufactured by Dainippon Ink & Chemicals, Inc.); Olex No.340 Clear (manufactured by Chyugoku Toryo Co., Ltd.); Sunrad H-601, RC-750, RC-700, RC-600, RC-500, RC-611 and RC-612 (manufactured by Sanyo Kaseikogyo Co., Ltd.); SP-1509 and SP-1507 (manufactured by Syowa Kobunshi Co., Ltd.); RCC-15C (manufactured by Grace Japan Co., Ltd.) and Aronix M-6100, M-8030 and M-8060 (manufactured by Toagosei Co., Ltd.).

Specific examples include, for example: trimethylol propane triacrylate, ditrimethylol propane tetracrylate, pentaerythritol triacrylate, pentaerythritol tetracrylate, dipentaerythritol hexaacrylate and alkyl modified dipentaerythritol pentaacrylate.

The UV-curable resin layer thus obtained may preferably contain inorganic or organic particles in order to attain the following characteristics: (i) improving scratch resistance, (ii) providing lubrication and (iii) controlling refractive index.

Inorganic particles to be contained in a hard coat layer include, for example: silicon oxide, titanium oxide, aluminum oxide, tin oxide, indium ovide, ITO, zinc oxide, zirconium oxide, magnesium oxide, calcium carbonate, talc, clay, calcined kaolin, calcined calcium silicate, hydrated calcium silicate, aluminum silicate, magnesium silicate and calcium phosphate. Of these, silicon oxide, titanium oxide, aluminum oxide, zirconium oxide, magnesium oxide are specifically preferable.

Organic particles include, for example: particles of polymethacrylic acid methyl acrylate resin, acryl styrene based resin, polymethyl methacrylate resin, silicon-containing resin, polystyrene based resin, polycarbonate resin, benzoguanamine based resin, melamine based resin, polyolefin based resin, polyester based resin, polyamide based resin, polyimide based resin and polyfluorinated ethylene based resin. Specifically preferable organic particles include, for example: particles of cross-linked polystylene (such as SX-130H, SX-200H and SX-350H manufactured by Soken Chemical & Engineering Co., Ltd.) and polymethyl methacrylate (such as MX150 and MX300 manufactured by Soken Chemical & Engineering Co., Ltd.).

The mean particle diameter of the particles is preferably from 0.01 to 5 μm, more preferably from 0.1 to 5 μm, and specifically preferably from 0.1 to 4 μm. The hard coat layer preferably contains two or more kinds of particles having different diameters. The mixing ratio of particles and UV-curable resin composition is preferably from 0.1 to 30 weight parts of particles per 100 weight parts of resin composition.

The hard coat layer is preferably a layer having a mean center-line roughness (Ra: prescribed by JIS B 0601) of 0.001 to 0.1 μm or may be an anti-glare layer having Ra value of 0.1 to 1 μm. The mean center line roughness (Ra) is preferably measured by means of a non-contact surface micro morphology mieter, for example, WYKO Optical-Profiler NT-2000 manufactured by Veeco Instruments.

The hard coat layers can be applied by any method well known in the art, for example: a gravure coater, a dip coater, a reverse coater, a wire bar coater, a die coater and ink jet printing. After coating, the hard coat layer is dried by heating, followed by being subjected to hardening treatment.

Light sources to cure layers of UV curable-resin by photo-curing reaction are not specifically limited, and any light source may be used as far as UV ray is generated. For example, a low-pressure mercury lamp, a medium-pressure mercury lamp, a high-pressure mercury lamp, an ultrahigh-pressure mercury lamp, a carbon arc lamp, a metal halide lamp and a xenon lamp may be utilized. The preferable irradiation quantity of light may be changed depending on the type of lamp, however, it is generally from 5 to 150 mJ/cm², and is more preferably from 20 to 100 mJ/cm².

Irradiation with ionizing radiation onto the hard coat layer is preferably carried out while tension in the transportation direction is applied to the film, and more preferably it is carried out while tension in the lateral direction is also applied to the file. The tension to be applied is preferably 30-300 N/m. The method to apply the tension is not specifically limited. The tension may be applied to the film transportation direction on a backroll or may be applied to the lateral direction or to the biaxial directions by using a tenter, whereby a film having further improved flatness is obtained.

The coating solution for the hard coat layer may contain solvent which may be a mixed solution or a diluted solution. Examples of an organic solvent contained in the coating solution include: hydrocarbons (toluene and xylene), alcohols (methanol, ethanol, isopropanol, butanol and cyclohexanol), ketones (acetone, methyl ethyl ketone and methyl isobutyl ketone), esters (methyl acetate, ethyl acetate and methyl lactate), glycol ethers and other organic solvents. These organic solvents may be also used in combination. The above mentioned organic solvents preferably contain propylene glycol monoalkyl ether (the alkyl having 1 to 4 carbon atoms) or propylene glycol monoalkyl ether acetate (the alkyl having 1 to 4 carbon atoms) in an amount of 5% by weight or more, and more preferably 5-80% by weight.

The hard coat layer may be preferably mixed with a fluorine-containing surfactant or a silicone surfactant, which will be described below. The contents of these surfactants are preferably 0.01-3% by weight based on the solid content of the coating solution.

The hard coat layer may have a laminated structure containing two or more layers, one of which may be an anti-electrostatic layer containing conductive particles or an ionic polymer. One of the layers may also contain a color adjusting agent to have a color adjusting function to be used as a color filter for various kinds of displays, or may contain an electromagnetic wave blocking material or an IR ray absorbent to have respective functions.

The hard coat layer is preferably irradiated with UV rays after the layer is applied and dried. The duration of irradiation is preferably 0.1-60 seconds in order to obtain a sufficient amount of irradiation. The duration is more preferably 0.1-10 seconds in view of hardening efficiency and working efficiency.

The illuminance of the ionizing radiation is preferably 50-150 mW/cm².

(Back Coat Layer)

The antireflection film of the present invention having an ionizing radiation curable resin layer on one surface of the cellulose ester film is preferably provided with a back coat layer on the other surface of the cellulose ester film. A back coat film is provided on a cellulose ester film to prevent curling which may occur when an ionizing radiation curable resin layer or other layers are formed on a cellulose ester film by means of a coating method or by CVD. Namely, by adding a counter force to curl toward the back coat side, the force to curl toward the ionizing radiation curable resin layer side may be balanced out. Also, a back coat layer preferably has a feature to prevent blocking. For this purpose, particles are preferably added to a coating composition of back coat layer.

Particles preferably added to the back coat layer include inorganic particles, for example, silicon dioxide, titanium dioxide, aluminum oxide, zirconium oxide, calcium carbonate, talc, clay, calcined kaolin, calcined calcium silicate, tin oxide, indium oxide, zinc oxide, ITO, hydrated calcium silicate, aluminum silicate, magnesium silicate and calcium phosphate. Particles containing silicon are preferably used to minimize the haze. Of these, silicon dioxide is specifically preferable.

Inorganic particle available on the market include, for example: AEROSIL R972, R927V, R974, R812, 200, 200V, 300, R202, OX50 and TT600, which are manufacture by Nippon Aerosil Co. Ltd. Particles of zirconium oxide available on the market include, for example: AEROSIL R976 and R811 manufacture by Nippon Aerosil Co. Ltd. Particles of polymer include, for example: silicone resin, fluorine-contained resin and acryl resin. Among these, silicone resin, especially three dimensionally networked silicone resin is preferably used. Examples of silicone resins available on the market include TOSPERL 103, 105, 108, 120, 145, 3120 and 240, which are manufactured by Toshiba Silicone Co., Ltd.

Among the particles listed above, AEROSIL 200V and AEROSIL R972V are specifically preferable with respect to effectively preventing blocking while minimizing haze. The kinetic friction coefficient of the rear side of the ionizing radiation curable resin layer in the present invention is preferably less than 0.9 and specifically preferably from 0.1 to 0.9.

The content of particles contained in the back coat layer is preferably 0.1-50% by weight and more preferably 0.1-10% by weight. The increase in haze after the hard coat film is provided with a back coat layer is preferably not more than 1%, more preferably not more than 0.5% and specifically preferably 0.0-0.1%.

The back coat layer is formed by means of a coating method using a coating solution containing a solvent which dissolves and/or swells cellulose ester (hereafter this type of solvent is referred to as “type A solvent”). The solvent may occasionally contain a solvent which does not dissolve nor swell cellulose ester (hereinafter this type of solvent is referred to as “type B solvent”). The mixing ratio of these solvents and the amount of the coating solution to be used for forming a back coat layer is appropriately determined depending on the extent of the curl and the type of the resin used for the antireflection film.

In order to have a larger effect to preventing curl in the film, the mixing ratio of type A solvent is increased while the ratio of type B solvent is decreased. The mixing ratio of type A solvent to type B solvent is preferably 10 to 0 through 1 to 9. Examples of type A solvent include: dioxane, acetone, methyl ethyl ketone, N,N-dimethyl formamide, methyl acetate, ethyl acetate, trichloroethylene, methylene chloride, ethylene chloride, tetrachloroethane, trichloroethane and chloroform. Examples of type B solvent include: methanol, ethanol, n-propyl alcohol, i-propyl alcohol, n-butanol, cyclohexanol and hydrocarbons (such as toluene and xylene).

The back coat layer is coated by means of, for example: a gravure coater, a dip coater, a reverse coater, a wire-bar coater, a die coater, a spray coater and ink-jet printing, in a thickness of preferably from 1 to 100 μm and specifically preferably from 5 to 30 μm. Resins utilized as a binder in a back coat layer include, for example: (i) vinyl type homopolymers or copolymers such as a vinyl chloride/vinyl acetate copolymer, a vinyl chloride resin, a vinyl acetate resin, a copolymer of vinyl acetate and vinyl alcohol, a partially hydrolyzed vinyl chloride/vinyl acetate copolymer, a vinyl chloride/vinylidene chloride copolymer, a vinyl chloride/acrylonitrile copolymer, an ethylene/vinyl alcohol copolymer, a chlorinated polyvinylchloride, an ethylene/vinyl chloride copolymer and a ethylene/vinyl acetate copolymer; (ii) cellulose ester type resins such as cellulose nitrate, cellulose acetate propionate, cellulose diacetate, cellulose triacetate, cellulose acetate phthalate and cellulose acetate butylate; (iii) rubber type resins such as a copolymer of maleic acid and/or acrylic acid, a copolymer of acrylate ester, an acrylonitrile/stylene copolymer, a chlorinated polyethylene, an acrylonitrile/chlorinated polyethylene/stylene copolymer, a methylmethacrylate/butadiene/stylene copolymer, an acryl resin, a polyvinylacetal resin, a polyvinylbutyral resin, a polyester polyuretane resin, a polyether polyurethane resin, a polycarbonate polyurethane resin, a polyester resin, a polyether resin, a polyamide resin, an amino resin, a stylene/butadiene resin and a butadiene/acrilonitrile resin; (iv) a silicone type resin; and (v) a fluorine-containing type resin, however, the present invention is not limited thereto. Examples of acryl resins available on the market include homopolymers and copolymers produced from acryl or methacryl monomers, such as: Acrypet MD, VH, MF and V (manufactured by Mitsubisi Rayon Co., Ltd.), Hi Pearl M-4003, M-4005, M-4006, M-4202, M-5000, M-5001 and M-4501 (Negami Chemical Industrial Co., Ltd.), Dianal BR-50, BR-52, BR-53, BR-60, BR-64, BR-73, BR-75, BR-77, BR-79, BR-80, BR-82, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, BR-117 and BR-118 (manufactured by Mitsubisi Rayon Co., Ltd.). A resin used in the present invention may suitably be selected from the above examples.

Cellulose based resins such as diacetyl cellulose and cellulose acetate propionate are specifically preferable.

The coating order of a back coat layer on a cellulose ester film is not specifically limited, namely, a back coat layer may be formed before or after forming the ionizing radiation curable resin layer, however, when a back coat layer also functions as an antiblocking layer, the back coat layer is preferably formed before the opposite side layers. Coating of a back coat layer may preferably be divided in two or more times.

(Antireflection Layer)

Next, an antireflection layer according to the present invention will be explained.

(High Refractive Index Layer)

(Metal Oxide Particles of High Refractive Index Layer)

Metal oxide particles are contained in a high refractive index layer according to the present invention. The type of metal oxide particles is not specifically limited and utilized can be metal oxide provided with at least one element selected from Ti, Zr, Sn, Sb, Cu, Fe, Mn, Pb, Cd, As, Cr, Hg, Zn, Al, Mg, Si, P and S; and these metal oxide particles may be doped with a tiny amount of an atom of such as Al, In, Sn, Sb, Nb, a halogen element and Ta. Further, mixtures thereof can be also utilized. In the present invention, particularly, preferably utilized as a primary component are metal oxide particles of one type selected from zirconium oxide, antimony oxide, tin oxide, zinc oxide, indium tin oxide (ITO), tin oxide doped with antimony (ATO) and zinc antimonate and specifically preferable is indium tin oxide (ITO).

A mean particle diameter of primary particles of these metal oxide particles is preferably in a range of 10-200 nm and specifically preferably in a range of 10-150 nm. An average primary particle diameter of metal oxide particles was determined by observing 100 particles with a transmission electron microscope (TEM). An average diameter of circumscribing circles of the 100 particles was designated as the average diameter of the particles.

When the particle size is excessively small, aggregation is liable to be caused to deteriorate dispersibility. While, when the particle size is excessively large, haze is extremely raised, and it is unfavorable. The shape of metal oxide particles is preferably a rice grain form, a spherical form, a cubic form, a corn form, a needle form or an irregular form.

In particular, a refractive index of a high refractive index layer is preferably higher than that of transparent substrate film as a support and in a range of 1.50-1.70, based on measurement at 23° C. with a wavelength of 550 nm. Since means to adjust a refractive index of a high refractive index layer are primarily the type of metal oxide particles and the addition amount, a refractive index of metal oxide particles is preferably 1.80-2.60 and more preferably 1.85-2.50.

Metal oxide particles may be surface treated with an organic compound. By modifying the surface of metal oxide particles with an organic compound, dispersion stability in an organic solvent is improved and control of a dispersed particle size becomes easy as well as it is also possible to restrain aggregation and precipitation due to aging. Therefore, the amount of surface modification with an organic compound is 0.1-5 weight % and more preferably 0.5-3 weight %, against metal oxide particles. Specific examples of an organic substance utilized for the surface treatment include polyol, alkanol amine, stearic acid, a silane coupling agent and a titanate coupling agent. Among them, a silane coupling agent described later is preferred. At least two types of surface treatments may be utilized in combination.

A thickness of a high refractive index layer containing the aforesaid metal oxide particles is preferably 5 nm-1 μm, more preferably 10 nm-0.2 μm and most preferably 30 nm-0.1 μm.

The ratio of metal oxide particles utilized to a binder such as ionizing radiation curable resin described later differs depending on such as the type and particle size of metal oxide particles, however, is preferably approximately 1/2-2/1 based on a volume ratio of the former to the latter.

The using amount of metal oxide particles utilized in the present invention is preferably 5-85 weight % in a high refractive index layer, more preferably 10-80 weight % and most preferably 20-70 weight %. Such as a desired refractive index and effects of the present invention cannot be achieved at an excessively small using amount, while deterioration of layer strength may be caused with an excessive amount.

The above-described metal oxide particles are supplied to a coating solution, which forms a high refractive index layer, in a state of dispersion being dispersed in a medium. As a dispersion medium of metal oxide particles, preferable is a liquid having a boiling point of 60-170° C. Specific examples of a dispersion medium include water, alcohol (such as methanol, ethanol, isopropanol, butanol and benzylalcohol), ketone (such as acetone, methyl ethyl ketone, methyl isobutyl ketone and cyclohexanone), ketone alcohol (such as diacetone alcohol), ester (such as methyl acetate, ethyl acetate, propyl acetate, butyl acetate, methyl formate, ethyl formate, propyl formate and butyl formate), aliphatic hydrocarbon (such as hexane and cyclohexane), hydrocarbon halogenide (such as methylene chloride, chloroform and carbon tetrachloride), aromatic hydrocarbon (such as benzene, toluene and xylene), amide (such as dimethylformamide, dimethylacetamide and n-methylpyrrolidone), ether (such as diethyl ether, dioxane and tetrahydrofuran) and ether alcohol (such as 1-methoxy-2-propanol). Among them, toluene, xylene, methyl ethyl ketone, methyl isobutyl ketone, cyclohexanone and butanol are specifically preferable.

Further, metal oxide particles can be dispersed in a medium by use of a homogenizer. Examples of a homogenizer include a sand grinder mill (for example, a beads mill equipped with a pin), a high speed impeller mill, a baffle mill, a roller mill, an atliter and a colloidal mill. A sand grinder mill and a high speed impeller mill are specifically preferable. Further, a preliminary dispersion may be performed. Examples of a homogenizer utilized in a preliminary dispersion include a ball mill, a three-roll mill, a kneader and an extruder.

In the present invention, further, metal oxide particles provided with a core/shell structure may be further incorporated. One layer of a shell may be formed on the circumference of a core or plural layers of shells may be formed to further improve light resistance. It is preferable to completely cover the core with a shell.

As a core, utilized can be titanium oxide (such as a rutile type, an anatase type and an amorphous type), zirconium oxide, zinc oxide, cerium oxide, indium oxide doped with tin and tin oxide doped with antimony, however, titanium oxide of a rutile type is preferably utilized as a primary component.

A shell preferably utilizes an inorganic compound other than titanium oxide as a primary component and is formed from metal oxide or metal sulfide. For example, inorganic compounds comprised of such as silicon dioxide (silica), aluminum oxide (alumina), zirconium oxide, zinc oxide, tin oxide, antimony oxide, indium oxide, iron oxide and zinc sulfide as a primary component can be utilized. Among them, preferably utilized are alumina, silica and zirconia (zirconium oxide). Further, mixtures thereof are also preferable.

The coverage of a shell against a core is 2-50 weight %, preferably 3-40 weight % and furthermore preferably 4-25 weight %, based on a mean coverage. When the coverage of a shell is large, refractive index of particles will decrease, while when the coverage is excessively small, light resistance will be deteriorated. At least two types of inorganic particles may be also utilized in combination.

As titanium oxide to form a core, one prepared by a liquid phase method or a gas phase method can be utilized. Further, as a method to form a shell around a core, utilized can be a method described in such as U.S. Pat. No. 3,410,708, Examined Japanese Patent Application Publication No. 58-47061, U.S. Pat. Nos. 2,885,366 and 3,437,502, British Patent No. 1,124,249, U.S. Pat. No. 3,383,231, British Patent Nos. 2,629,953 and 1,365,999.

(Metal Compound)

As metal compounds utilized in the present invention, compounds represented by following formula (2) or chelate compounds thereof can be utilized.
AₙMBₓ₋ₙ Formula (2)

wherein, M represents a metal atom, A represents a functional group which can be hydrolyzed, or a hydrocarbon group provided with a functional group which can be hydrolyzed, and B represents an atomic group which has made a covalent or ionic bond with metal atom M. x represents a valence of metal atom M and n represents an integer of not less than 2 and not more than x.

A functional group A capable of being hydrolyzed includes such as an alkoxy group, a halogen atom such as chlorine atom, an ester group and an amido group. Metal compounds belonging to above formula (2) include alkoxide provided with at least two alkoxy groups, which directly bond to the metal atom, or chelate compounds thereof. Preferable metal compounds include titanium alkoxide, zirconium alkoxide or chelate compounds thereof. Titanium alkoxide gives a rapid reaction rate and a high refractive index as well as easy handling, however, it may deteriorate light resistance due to the photocatalitic function when a large amount thereof is added. Zirconium alkoxide has a high refractive index; however, since it is liable to be milky-whitened, care should be taken of such as dew point control at the time of coating. Further, since titanium alkoxide has an effect to accelerate the reaction of ultraviolet curable resin and metal alkoxide, it is possible to improve physical properties of coated film even with a small amount of addition.

In the present invention, surprisingly, by applying a low refractive index layer, which is accumulated on a specific hard coat layer and a specific high refractive index layer containing a metal compound, scratch resistance of said low refractive index layer has been significantly improved.

Titanium alkoxide includes such as tetramethoxy titanium, tetraethoxy titanium, tetra-iso-propoxy titanium, tetra-n-propoxy titanium, tetra-n-butoxy titanium, tetra-sec-butoxy titanium and tetra-tert-butoxy titanium.

Zirconium alkoxide includes such as tetramethoxy zirconium, tetraethoxy zirconium, tetra-iso-propoxy zirconium, tetra-n-propoxy zirconium, tetra-n-butoxy zirconium, tetra-sec-butoxy zirconium and tetra-tert-butoxy zirconium.

A preferable chelating agent, which forms a chelate compound by coordinating to a metal compound, includes alkanol amines such as diethanol amine and triethanol amine; glycols such as ethylene glycol, diethylene glycol and propylene glycol; acetylacetone and ethyl acetoacetate; having a molecular weight of not more than 10,000. By utilizing these chelating agents, a chelate compound, which is stable against such as mixing of water content and excellent in a bolstering effect of coated layer, can be formed.

The addition amount of a metal compound is preferably adjusted to 0.3-5 weight % based on the content of metal oxide arising from said metal compound contained in a high refractive index layer. Scratch resistance is not sufficient when the content is less than 0.3 weight %, while light resistance tends to be deteriorated when the content is over 5 weight %.

(Ionization Radiation Curable Resin)

Ionization radiation curable resin is added as a binder for metal oxide particles to improve film forming capability and physical properties of coated film. As ionization radiation curable resin, utilized can be monomer or oligomer provided with at least two functional groups which generate a polymerization reaction directly with irradiation of ionization radiation such as ultraviolet rays and electron rays or indirectly with a function of a photo-polymerization initiator. The functional group includes a group having an unsaturated double bond such as a (meth)acryloyloxy group, an epoxy group and silanol group. Among them, radical polymerizing monomer or oligomer which has at least two unsaturated double bonds is preferably utilized. A photopolymerization initiator may be appropriately employed in combination. Such ionization radiation curable resin includes a polyfunctional acrylate compound, and preferably is a compound selected from a group comprising pentaerythritol polyfunctional acrylate, dipentaerythritol polyfunctional acrylate, pentaerythritol polyfunctional methacrylate and dipentaerythritol polyfunctional methacrylate. Herein, a polyfunctional acrylate compound is a compound provided with at least two acryloyloxy groups and/or methacryloyloxy groups.

Monomer of a polyfunctional acrylate compound preferably includes such as ethylene glycol diacrylate, diethylene glycol diacrylate, 1,6-hexanediol diacrylate, neopentyl glycol diacrylate, trimethylolpropane triacrylate, trimethylolethane triacrylate, tetramethylolmethane triacrylate, tetramethylolmethane tetraacrylate, pentaglycelol triacrylate, pentaerythritol diacrylate, pentaerythritol triacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris(acryloyloxyethyl) isocyanulate, ethylene glycol dimethacrylate, diethylene glycol dimethacrylate, 1,6-hexanediol dimethacrylate, neopentyl glycol dimethacrylate, trimethylolpropane trimethacrylate, trimethylolethane trimethacrylate, tetramethylolmethane trimethacrylate, tetramethylolmethane tetramethacrylate, pentaglycelol trimethacrylate, pentaerythritol dimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate and dipentaerythritol hexamethacrylate. These compounds each are utilized alone or in combination of at least two types. Further, oligomer such as dimmer or trimer of the above-described monomer may also be utilized.

Also, preferably usable are the UV curable resins described above as ionizing radiation curable resins to be used for a hard coat layer including, for example: a UV-curable urethane acrylate resin, a UV-curable polyester acrylate resin, a UV-curable epoxy acrylate resin, a UV-curable polyol acrylate resin and a UV-curable epoxy resin.

The addition amount of ionization radiation curable resin is preferably not less than 15 weight % and not more than 50 weight % in the solid content, in case of a high refractive index composition.

To accelerate curing of ionization radiation curable resin according to the present invention, it is preferable to incorporate a photo-polymerization initiator and an acrylic compound provided with at least two unsaturated bonds, which is capable of polymerization, in a molecule, at a weight ratio of 3/7-1/9.

Specific examples of a photo-polymerization initiator include such as acetophenone, benzophenone, hydroxybenzophenone, Michler's ketone, α-amyloxime ester and thioxanthone; and derivatives thereof, however, are not limited thereto.

(Solvent)

An organic solvent utilized for coating of a high refractive index layer of the present invention includes, for example, alcohols (such as methanol, ethanol, propanol, isopropanol, butanol, isobutanol, secondary butanol, tertiary butanol, pentanol, hexanol, cyclohexanol and benzyl alcohol), polyhydric alcohols (such as ethylene glycol, diethylene glycol, triethylene glycol, polyethylene glycol, propylene glycol, dipropylene glycol, polypropylene glycol, butylenes glycol, hexanediol, pentanediol, glycerin, hexanetriol and thiodiglycol), polyhydric alcohol ethers (such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether and propylene glycol monophenyl ether), amines (such as ethanol amine, diethenol amine, triethenol amine, N-methyl diethanol amine, N-ethyl diethanol amine, morpholine, N-ethyl morpholine, ethylene diamine, diethylene diamine, triethylene tetramine, tetraethylene pentamine, polyethylene imine, pentametyldiethylene triamine and tetramethylpropylene diamine), amides (such as formamide, N,N-dimethyl formamide and N,N-dimethyl acetoamide), heterocyclic rings (such as 2-pyrrolidone, N-methyl-2-pyrrolidone, cyclohexyl pyrrolidone, 2-oxazoline and 1,3-dimethyl-2-imidazolidinone), sulfoxides (such as dimethylsulfoxide), sulfones (such as sulforane), urea, acetonitrile and acetone, however, alcohols, polyhydric alcohols and polyhydric alcohol ethers are specifically preferred.

<Low Refractive Index Layer>

A refractive index of a low refractive index layer according to the present invention is lower than that of transparent substrate film as a support, and is preferably in a range of 1.30-1.45 based on a measurement at 23° C. and a wavelength of 550 nm.

A layer thickness of a low refractive index layer is preferably 5 nm-0.5 μm, more preferably 10 nm-0.3 μm and most preferably 30 nm-0.2 μm.

The low refractive index layer forming composition utilized in the present invention is constituted of hollow silica type particles as an essential component, the interior of which is porous or hollow, provided with (d) an organosilicon compound, which is represented by following formula (1), a hydrolyzed product thereof or a polycondensation product thereof and (e) an outer shell layer.

Formula (1) Si(OR)₄ (wherein, R represents an alkyl group and preferably an alkyl group having a carbon number of 1-4.)

In addition to this, a solvent and appropriately such as a silane coupling agent, a hardener and a surfactant may be incorporated.

[Hollow Silica Particles]

Hollow silica type particles, the interior of which is porous or hollow, provided with an outer shell layer represented by aforesaid (e), will now be explained.

Hollow silica type particles are (I) complex particles constituted of a porous particle and a cover layer arranged on the surface of said porous particle or (II) hollow particles, the interior of which is provided with a hollow and the hollow is filled with contents such as a solvent, a gas or a porous substance. Herein, at least either (I) complex particles or (II) hollow particles is contained in a low refractive index layer, or the both of them may be contained.

Herein, hollow particles are particles the interior of which is provided with a hollow, and the hollow is surrounded by a particle wall. The interior of the hollow is filled with the contents such as a solvent, a gas or a porous substance which have been utilized in preparation. The mean particle size of such hollow particles is preferably in a range of 5-300 nm and preferably of 10-200 nm. The mean particle size of hollow particles utilized is appropriately selected depending on the thickness of the formed transparent cover film and is preferably in a range of 2/3-1/10 of the layer thickness of the transparent cover film of such as a formed low refractive index layer. These hollow particles are preferably utilized in a state of being dispersed in a suitable medium to form a low refractive index layer. As dispersing medium, water, alcohol (such as methanol, ethanol and isopropanol), ketone (such as methyl ethyl ketone and methyl isobutyl ketone) and ketone alcohol (such as diacetone alcohol) are preferable.

A thickness of the cover layer of a complex particle or the thickness of the particle wall of a hollow particle is preferably in a range of 1-20 nm and more preferably in a range of 2-15 nm. In the case of a complex particle, when a thickness of the cover layer is less than 1 nm, a particle may not be completely covered to allow such as silicate monomer or oligomer having a low polymerization degree as a coating component described later to immerse into the interior of the complex particle resulting in decrease of porousness of the interior, whereby an effect of a low refractive index may not be obtained. Further, when a thickness of the cover layer is over 20 nm, the aforesaid silicate monomer or oligomer never immerses into the interior, however, the porosity (a micro-pour volume) of a complex particle may be decreased, resulting in an insufficient effect of a low refractive index. Further, in the case of a hollow particle, particle shape may not be kept when a thickness of the particle wall is less than 1 nm, while an effect of a low refractive index may not be obtained when a thickness of the particle wall is not less than 20 nm.

The cover layer of a complex particle or the particle wall of a hollow particle is preferably comprised of silica as a primary component. Further, components other than silica may be incorporated and specific examples include such as Al₂O₃, B₂O₃, TiO₂, ZrO₂, SnO₂, CeO₂, P₂O₃, Sb₂O₃, MoO₃, ZnO₂, and WO₃. A porous particle to constitute a complex particle includes those comprised of silica, those comprised of silica and an inorganic compound other than silica and those comprised of such as CaF₂, NaF, NaAlF₆ and MgF. Among them, specifically preferable is a porous particle comprised of a complex oxide of silica and an inorganic compound other than silica. An inorganic compound other than silica includes one type or at least two types of such as Al₂O₃, B₂O₃, TiO₂, ZrO₂, SnO₂ CeO₂, P₂O₃, Sb₂O₃, MoO₃, ZnO₂ and WO₃. In such a porous particle, mole ratio MOₓ/SiO₂ is preferably in a range of 0.0001-1.0 and more preferably of 0.001-0.3 when silica is represented by SiO₂ and an inorganic compound other than silica is represented by an equivalent oxide (MOₓ). A porous particle having mole ratio MOₓ/SiO₂ of less than 0.0001 is difficult to be prepared and the pore volume is small to unable preparation of a particle having a low refractive index. Further, when mole ratio MOₓ/SiO₂ of a porous particle is over 1.0, the pore volume becomes large due to a small ratio of silica and it may be further difficult to prepare a particle having a low refractive index.

A pore volume of such a porous particle is preferably in a range of 0.1-1.5 ml/g and more preferably of 0.2-1.5 ml/g. When the pore volume is less than 0.1 ml/g, a particle having a sufficiently decreased refractive index cannot be prepared, while, when it is over 1.5 ml/g, strength of a particle is decreased and strength of the obtained cover film may be decreased.

Herein, the pore volume of such a porous particle can be determined by a mercury pressurized impregnation method. Further, a content of a hollow particle includes such as a solvent, a gas and a porous substance which have been utilized at preparation of the particle. In a solvent, such as a non-reacted substance of a particle precursor which is utilized at hollow particle preparation and a utilized catalyst may be contained. Further, a porous substance includes those comprising compounds exemplified in the aforesaid porous particle. These contents may be those comprising single component or mixture of plural components.

As a manufacturing method of such hollow particles, a preparation method of complex oxide colloidal particles, disclosed in paragraph Nos. [0010]-[0033] of JP-A No. 7-133105 (JP-A refers to Japanese Patent Publication Open to Public Inspection), is suitably applied. Specifically, in the case of a complex particle being comprised of silica and an inorganic compound other than silica, the hollow particle is manufactured according to the following first-third processes.

First Process: Preparation of Porous Particle Precursor

In the first process, alkaline aqueous solutions of a silica raw material and of an inorganic compound raw material other than silica are independently prepared or a mixed aqueous solution of a silica raw material and an inorganic compound raw material other than silica is prepared, in advance, and this aqueous solution is gradually added into an alkaline aqueous solution having a pH of not less than 10 while stirring depending on the complex ratio of the aimed complex oxide, whereby a porous particle precursor is prepared.

As a silica raw material, silicate of alkali metal, ammonium or organic base is utilized. As silicate of alkali metal, utilized are sodium silicate (water glass) and potassium silicate. Organic base includes quaternary ammonium salt such as tetraethylammonium salt; and amines such as monoethanolamine, diethanolamine and triethanolamine. Herein, an alkaline solution, in which such as ammonia, quaternary ammonium hydroxide or an amine compound is added in a silicic acid solution, is also included in silicate of ammonium or silicate of organic base.

Further, as a raw material of an inorganic compound other than silica, utilized is an alkali-soluble inorganic compound. Specific examples include oxoacid of an element selected from such as Al, B, Ti, Zr, Sn, Ce, P, Sb, Mo, Zn and W; alkali metal salt, alkaline earth-metal salt, ammonium salt and quaternary ammonium salt of said oxoacid. More specifically, sodium alminate, sodium tetraborate, ammonium zirconyl carbonate, potassium antimonite, potassium stannate, sodium alminosilicate, sodium molybdate, cerium ammonium nitrate and sodium phosphate are suitable.

The pH value of a mixed aqueous solution changes simultaneously with addition of these aqueous solutions, however, operation to control the pH value into a specific range is not necessary. The aqueous solution finally takes a pH value determined by the types and the mixing ratio of inorganic oxide. At this time, the addition rate of an aqueous solution is not specifically limited. Further, dispersion of a seed particle may be also utilized as a starting material at the time of manufacturing of complex oxide particles. Said seed particles are not specifically limited, however, particles of inorganic oxide such as SiO₂, Al₂O₃, TiO₂ or ZrO₂ or complex oxide thereof are utilized, and generally sol thereof can be utilized. Further, a porous particle precursor dispersion prepared by the aforesaid manufacturing method may be utilized as a seed particle dispersion. In the case of utilizing a seed particle dispersion, after the pH of a seed particle dispersion is adjusted to not lower than 10, an aqueous solution of the aforesaid compound is added into said seed particle dispersion while stirring. In this case pH control of dispersion is not necessarily required. By utilizing seed particles in this manner, it is easy to control the particle size of prepared particles and particles having a uniform size distribution can be obtained.

A silica raw material and an inorganic compound raw material, which were described above, have a high solubility at alkaline side. However, when the both are mixed in pH range showing this high solubility, the solubility of an oxoacid ion such as a silicic acid ion and an aluminic acid ion will decrease, resulting in precipitation of these complex products to form particles or to be precipitated on a seed particle causing particle growth. Therefore, at the time of precipitation and growth of particles, pH control in a conventional method is not necessarily required.

A complex ratio of silica and an inorganic compound other than silica is preferably in a range of 0.05-2.0 and more preferably of 0.2-2.0, based on mole ratio MOₓ/SiO₂, when an inorganic compound other than silica is converted to oxide (MOₓ). In this range, the smaller is the ratio of silica, increases the pore volume of porous particles. However, a pore volume of porous particles barely increases even when the mole ratio is over 2.0. On the other hand, a pore volume becomes small when the mole ratio is less than 0.05. In the case of preparing hollow particles, mole ratio of MOₓ/SiO₂ is preferably in a range of 0.25-2.0.

Second Process: Elimination of Inorganic Compounds Other Than Silica From Porous Particles

In the second process, at least a part of inorganic compounds other than silica (elements other than silica and oxygen) is selectively eliminated from the porous particle precursor prepared in the aforesaid first process. As a specific elimination method, inorganic compounds in a porous particle precursor are dissolving eliminated by use of such as mineral acid and organic acid, or ion-exchanging eliminated by being contacted with cationic ion-exchange resin.

Herein, a porous particle precursor prepared in the first process is a particle having a network structure in which silica and an inorganic compound element bond via oxygen. In this manner, by eliminating inorganic compounds (elements other than silica and oxygen) from a porous particle precursor, porous particles, which are more porous and have a large pore volume, can be prepared. Further, hollow particles can be prepared by increasing the elimination amount of inorganic compound (elements other than silica and oxygen) from a porous particle precursor.

Further, in advance to elimination of inorganic compounds other than silica from a porous particle precursor, it is preferable to form a silica protective film by adding a silicic acid solution which contains a silane compound having a fluorine substituted alkyl group, and is prepared by dealkalization of alkali metal salt of silica; or a hydrolyzable organosilicon compound, in a porous particle precursor dispersion prepared in the first process. The thickness of a silica protective film is 0.5-15 nm. Herein, even when a silica protective film is formed, since the protective film in this process is porous and has a thin thickness, it is possible to eliminate the aforesaid inorganic compounds other than silica from a porous particle precursor.

By forming such a silica protective film, the aforesaid inorganic compounds other than silica can be eliminated from a porous particle precursor while keeping the particle shape as it is. Further, at the time of forming a silica cover layer described later, the pore of porous particles is not blocked by a cover layer, and thereby the silica cover layer described later can be formed without decreasing the pore volume. Herein, when the amount of inorganic compound to be eliminated is small, it is not necessary to form a protective film because the particles will never be broken.

Further, in the case of preparation of hollow particles, it is preferable to form this silica protective film. At the time of preparation of hollow particles, a hollow particle precursor, which is comprised of a silica protective film, a solvent and insoluble porous solid within said silica protective film, is obtained when inorganic compounds are eliminated, and hollow particles are formed, by making a particle wall from a formed cover layer, when the cover layer described later is formed on said hollow particle precursor.

The amount of a silica source added to form the aforesaid silica protective film is preferably in a range to maintain the particle shape. When the amount of a silica source is excessively large, it may become difficult to eliminate inorganic compounds other than silica from a porous particle precursor because a silica protective film becomes excessively thick. As a hydrolizable organosilicon compound utilized to form a silica protective film, alkoxysilane represented by formula RₙSi(OR′)₄₋ₙ [R, R′: a hydrocarbon group such as an alkyl group, an aryl group, a vinyl group and an acryl group; n=0, 1, 2 or 3] can be utilized. Fluorine-substituted tetraalkoxysilane, such as tetramethoxysilane, tetraethoxysilane and tetraisopropoxysilane, is specifically preferably utilized.

As an addition method, a solution, in which a small amount of alkali or acid as a catalyst is added into a mixed solution of these alkoxysilane, pure water and alcohol, is added into the aforesaid dispersion of porous particles, and silicic acid polymer formed by hydrolysis of alkoxysilane is precipitated on the surface of inorganic oxide particles. At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

In the case that a dispersion medium of a porous particle precursor is water alone or has a high ratio of water to an organic solvent, it is also possible to form a silica protective film by use of a silicic acid solution. In the case of utilizing a silicic acid solution, a predetermined amount of a silicic acid solution is added into the dispersion and alkali is added simultaneously, to precipitate silicic acid solution on the porous particle surface. Herein, a silica protective film may also be formed by utilizing a silicic acid solution and the aforesaid alkoxysilane in combination.

Third Process: Formation of Silica Cover Layer

In the third process, by addition of such as a hydrolyzable organosilicon compound containing a silane compound provided with a fluorine substituted alkyl group, or a silicic acid solution, into a porous particle dispersion (into a hollow particle dispersion in the case of hollow particles), which is prepared in the second process, the surface of particles is covered with a polymer substance of such as a hydrolyzable organosilicon compound or a silicic acid solution to form a silica cover layer.

As a hydrolyzable organosilicon-compound utilized for formation of a silica cover layer, alkoxysilane represented by formula RₙSi(OR′)₄₋ₙ [R, R′: a hydrocarbon group such as an alkyl group, an aryl group, a vinyl group and an acryl group; n=0, 1, 2 or 3], as described before, can be utilized. Tetraalkoxysilane such as tetramethoxysilane, tetraethoxysilane and tetraisopropoxysilane are specifically preferably utilized.

As an addition method, a solution, in which a small amount of alkali or acid as a catalyst is added into a mixed solution of these alkoxysilane, pure water and alcohol, is added into the aforesaid dispersion of porous particles (a hollow particle precursor in the case of hollow particles), and silicic acid polymer formed by hydrolysis of alkoxysilane is precipitated on the surface of porous particles (a hollow particle precursor in the case of hollow particles). At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

In the case that a dispersion medium of porous particles (a hollow particle precursor in the case of hollow particles) is water alone or a mixed solution of water with an organic solvent having a high ratio of water to an organic solvent, it is also possible to form a cover layer by use of a silicic acid solution. A silicic acid solution is an aqueous solution of lower polymer of silicic acid which is formed by ion-exchange and dealkalization of an aqueous solution of alkali metal silicate such as water glass.

A silicic acid solution is added into a dispersion of porous particles (a hollow particle precursor in the case of hollow particles), and alkali is simultaneously added to precipitate silicic acid lower polymer on the surface of porous particles (a hollow particle precursor in the case of hollow particles). Herein, silicic acid solution may be also utilized in combination with the aforesaid alkoxysilane to form a cover layer. The addition amount of an organosilicon compound or a silicic acid solution, which is utilized for cover layer formation, is as much as to sufficiently cover the surface of colloidal particles and the solution is is added into a dispersion of porous particles (a hollow particle precursor in the case of hollow particles) at an amount to make a thickness of the finally obtained silica cover layer of 1-20 nm. Further, in the case that the aforesaid silica protective film is formed, an organosilicon compound or a silicic acid solution is added at an amount to make a thickness of the total of a silica protective film and a silica cover layer of 1-20 nm.

Next, a dispersion of particles provided with a cover layer is subjected to a thermal treatment. By a thermal treatment, in the case of porous particles, a silica cover layer, which covers the surface of porous particles, becomes minute to prepare a dispersion of complex particles comprising porous particles covered with a silica cover layer. Further, in the case of a hollow particle precursor, the formed cover layer becomes minute to form a hollow particle wall, whereby a dispersion of hollow particles provided with a hollow, the interior of which is filled with a solvent, a gas or a porous solid, is prepared.

Thermal treatment temperature at this time is not specifically limited provided being so as to block micro-pores of a silica cover layer, and is preferably in a range of 80-300° C. At a thermal treatment temperature of lower than 80° C., a silica cover layer may not become minute to completely block the micro-pores or the treatment time may become long. Further, when a prolonged treatment at a thermal treatment temperature of higher than 300° C. is performed, particles may become minute and an effect of a low refractive index may not be obtained.

A refractive index of inorganic particles prepared in this manner is as low as 1.42. It is estimated that the refractive index becomes low because such inorganic particles maintain porous property in the interior of porous particles or the interior is hollow.

A content of hollow silica particles, the interior of which is porous or hollow, in a low refractive index layer is preferably 10-50 weight %. The content is preferably not less than 15 weight % to obtain an effect of a low refractive index, and a binder component become small to give insufficient layer strength when the content is over 50 weight %. The content is specifically preferably 20-50 weight %.

With respect to an organosilicon compound represented by aforesaid formula (1), R in the formula represents an alkyl group having a carbon number of 1-4.

Specifically, tetraalkoxysilane such as tetramethoxysilane, tetraethoxysilane and tetraisopropoxysilane is preferably utilized.

As an addition method into a low refractive index layer, a solution, in which a small amount of alkali or acid as a catalyst is added into a mixed solution of these alkoxysilane, pure water and alcohol, is added into the aforesaid dispersion of hollow silica type particles, and silicic acid polymer formed by hydrolysis of alkoxysilane is precipitated on the surface of hollow silica type particles. At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

Further, in the present invention, silane compounds containing a fluorine substituted alkyl group, which are represented by following formula (3), can be also incorporated in a low refractive index layer.

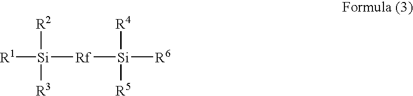

Silane compounds containing a fluorine substituted alkyl group, which are represented by aforesaid formula (3), will be now explained.

In the formula, R¹—R⁶ represent an alkyl group having a carbon number of 1-16 and preferably of 1-4, a halogenated alkyl group having a carbon number of 1-6 and preferably of 1-4, an aryl group having a carbon number of 6-12 and preferably of 6-10, an alkylaryl group and an arylalkyl group, having a carbon number of 7-14 and preferably of 7-12, an alkenyl group having a carbon number of 2-8 and preferably of 2-6, an alkoxy group having a carbon number of 1-6 and preferably of 1-3, hydrogen atom or a halogen atom.

Rf represents —(CₐH_{b}F_{c})—, “a” represents an integer of 1-12, “b+c” is “2a”, and “b” and “c” each represent 0 or an integer of 1-24. As such Rf, a group, provided with a fluoroalkylene group and a alkylene group, is preferable. Specifically, such a fluorine-containing silicone type compound includes such as methoxysilane compounds represented by (MeO)₃SiC₂H₄C₂F₄C₂H₄Si(MeO)₃, (MeO)₃SiC₂H₄C₄F₈C₂H₄Si(MeO)₃, (MeO)₃SiC₂H₄C₆F₁₂C₂H₄Si(MeO)₃, (H₅C₂O)₃SiC₂H₄C₄F₈C₂H₄Si(H₅C₂O)₃ and (H₅C₂O)₃SiC₂H₄C₆F₁₂C₂H₄Si (H₅C₂O)₃(MeO)₃.

When a silane compound provided with a fluorine-containing alkyl group is incorporated as a binder, since the formed transparent film it self is provided with hydrophobicity, invasion by water content or chemicals such as acid and alkali into the transparent film is restrained even when the transparent film is not made sufficiently minute to be porous or have cracks or voids. Further, particles such as metal contained in the substrate surface or the underlying conductive layer will never react with water content or chemicals such as acid and alkali. Therefore, such transparent film is provided with an excellent chemical resistance.

Further, when a silane compound provided with a fluorine-containing alkyl group is incorporated as a binder, sliding property in addition to such hydrophobicity is excellent (contact resistance is low), therefore transparent film having an excellent scratch strength can be obtained. Further, when a binder contains a silane compound provided with a fluorine-containing alkyl group having such a constituent unit, it is possible to form transparent film having an excellent adhesion with a conductive layer, in the case of a conductive layer being arranged under the film, because shrinkage ratio of the binder is same as or nearly equal to that of the conductive layer. Further, at the time of thermal treatment of transparent film, a conductive layer will never peeled off due to difference of shrinkage rate to generate a portion without electrical contact in a transparent conductive layer. Therefore, sufficient conductivity as the whole film can be maintained.

Transparent film containing a silane compound provided with a fluorine-containing alkyl group, and hollow silica type particles the interior of which is porous or hollow, provided with the aforesaid outer layer, can form transparent film having an excellent in strength, such as film strength evaluated based on eraser strength or nail strength in addition to a strong scratch strength, as well as a high pencil hardness.

A silane coupling agent may be incorporated in a low refractive index layer according to the present invention. A silane coupling agent includes methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropylmethoxysilane, γ-chloropropyltriacetoxysiane, 3,3,3-trifluoropropyltrimethoxysilane, γ-glycidyloxypropyltrimethoxysilane, γ-glycidyloxypropyltriethoxysilane, γ-(β-glycidyloxypethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane. γ-aminopropyltrimethoxysilane, γ-aminopropyltriethoxysilane, γ-mercaptotrimethoxysilane, γ-mercaptotriethoxysilane, N-β-(aminoethyl)-γ-aminopropyltrimethoxysilane and β-cyanoethyltriethoxysilane.

Further, examples of a silane coupling agent having a 2-substituting alkyl group against silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropylmethyldiethoxysilane, methylvinyldimethoxysilane and methylvinyldiethoxysilane.

Among them, vinylmethoxysilane, vinyltriethoxysilane, vinyltriacethoxysilane, vinyltrimethoxyethoxysilane, γ-acryloyloxypropyltrimethoxysilane and γ-methacryloyloxypropyltrimethoxysilane, which are provided with a double bond in a molecule; γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropylmethyldiethoxysilane, methylvinyldimethoxysilane and methylvinyldiethoxysilane, methylvinyldimethoxysilane and methylvinyldiethoxysilane as those having a 2-substituting alkyl group against silicon are preferable; and γ-acryloyloxypropyltrimethoxysilane, γ-methacryloyloxypropyltrimethoxysilane, γ-acryloyloxypropylmethyldimethoxysilane, γ-acryloyloxypropylmethyldiethoxysilane, γ-methacryloyloxypropylmethyldimethoxysilane and γ-methacryloyloxypropylmethyldiethoxysilane are specifically preferable.

At least two types of coupling agents may be utilized in combination. Other silane coupling agents in addition to the above-described silane coupling agents may be utilized. Other silane coupling agents include alkyl ester of orthosilicic acid (such as methyl orthosilicate, ethyl orthosilicate, n-propyl orthosilicate, i-propyl orthosilicate, n-butyl orthosilicate, sec-butyl orthosilicate and t-butyl orthosilicate) and hydrolyzed substances thereof.

Polymer utilized as another binder in a low refractive index layer includes such as polyvinyl alcohol, polyoxyethylene, polymethyl methacrylate, polymethyl acrylate, diacetyl cellulose, triacetyl cellulose, nitro cellulose, polyester and alkyd resin.

A low refractive index layer preferably contains a binder of 5-80 weight % as a whole. A binder is provided with a function to unite hollow silica particles and to maintain the structure of a low refractive index layer containing voids. The using amount of a binder is adjusted so as to maintain strength of a low refractive index layer without filling voids.

(Solvent)

A low refractive index layer according to the present invention preferably contains an organic solvent. Specific examples of an organic solvent include alcohol (such as methanol, ethanol, isopropanol, butanol and benzyl alcohol), ketone (such as acetone, methyl ethyl ketone, methyl isobutyl ketone and cyclohexanone), ester (such as methyl acetate, ethyl acetate, propyl acetate, butyl acetate, methyl formate, ethyl formate, propyl formate and butyl formate), aliphatic hydrocarbon (such as hexane and cyclohexane), halogenated hydrocarbon (such methylene chloride, chloroform and tetrachlorometane), aromatic hydrocarbon (such as benzene, toluene and xylene), amide (such as dimethyl formamide, dimethyl acetoamide and N-methylpyrrolidone), ether (such as diethyl ether, dioxane and tetrahydrofuran) and ether alcohol (such as 1-methoxy-2-propanol). Among them, specifically preferable are toluene, xylene, methyl ethyl ketone, methyl isobutyl ketone, cyclohexanone and butanol.

A solid concentration in a low refractive index layer coating composition is preferably 1-4 weight %, and uneven coating is hardly caused by setting said solid concentration to not more than 4 weight % as well as a drying load is decreased by setting the concentration to not less than 1 weight %.

(Fluorine-Containing Surfactant, Silicone Oil or Silicone Surfactant)

In the present invention, a fluorine-containing surfactant, silicone oil or a silicone surfactant is preferably incorporated in the aforesaid hard coat layer, high refractive index layer and low refractive index layer. By containing the above-described surfactant, it is effective to restrain uneven coating and to improve antistaining property of the film surface.

Fluorine-containing surfactants are those comprising monomer, oligomer and polymer containing a perfluoroalkyl group, as a mother nucleus, and include derivatives of such as polyoxyethylene alkylether, polyoxyethylene alkylallylehter and polyoxyethylene.

As a fluorine-containing surfactant, products available on the market can be also utilized, and listed are Surflon “S-381”, “S-382”, “SC-101”, “SC-102”, “SC-103” and “SC-104” (all are manufactured by Asahi Glass Co., Ltd.); Fluorad “FC-431” and “FC-173” (all are manufactured by Fluoro Chemical-Sumitomo 3M Co., Ltd.); Eftop (fluoro surfactant) “EF352”, “EF301” and “EF303” (all are manufactured by Shin-Akita Chemicals Co., Ltd. (JEMCO Inc.)); Schwego-Fluor “8035” and “8036” (all are manufacture by Schwegmann Co., Ltd.); “BM1000” and “BM1100” (all are manufactured B. M. Chemie Corp.) and Megafac “F-171” and “F-470” (all are manufactured by Dainippon Ink and Chemicals, Inc.).

A fluorine content ratio of a fluorine-containing surfactant in the present invention is 0.05-2% and preferably 0.1-1. The above-described fluorine-containing. surfactants may be utilized alone or in combination of at least two types, and may be utilized in combination with other surfactants.

Silicone oil or a silicone surfactant will now be explained.

Silicone oil utilized in the present invention can be roughly divided into straight silicone oil and modified silicone oil, depending on the type of an organic group bonding to a silicon atom. Straight silicone oil refers one to which a methyl group, a phenyl group and a hydrogen atom are bonded as a substituent. Modified silicone oil refers one having a constitutent portion which is secondarily derived from straight silicone oil. On the other hand, classification can be made according to reactivity of silicone oil. These will be summarized as follows.

Silicone Oil

1. Straight Silicone Oil

1-1. Non-Reactive Silicone Oil: Such as Dimethyl and Methylphenyl Derivatives

1-2. Reactive Silicone Oil: Such as Methyl/Hydrogen Substituted

2. Modified Silicone Oil

Modified silicone oil is one formed by introducing various organic groups into dimethyl silicone oil.

2-1. Non-Reactive Silicone Oil: Such as Alkyl, Alkyl/Alalkyl, Alkyl/Polyether, Polyether and Higher Aliphatic Acid Ester Substituted

Alkyl/alalkyl modified silicone oil is silicon oil in which a part of methyl groups of dimethyl silicone oil is substituted by a long-chain alkyl group or a phenylalkyl group.

Polyether modified silicone oil is a silicone type polymer surfactant in which a hydrophilic polyoxyalkylene is introduced into hydrophobic dimethylsilicone.

Higher fatty acid modified silicone oil is silicone oil in which a part of methyl groups of dimethylsilicone oil is substituted by higher aliphatic acid ester.

Amino modified silicone oil is silicone oil having a structure in which a part of methyl groups of the silicone oil is substituted by an amino alkyl group.

Epoxy modified silicone oil is silicone oil having a structure in which a part of methyl groups of the silicone oil is substituted by an alkyl group containing an epoxy group.

Carboxyl modified or alcohol modified silicone oil is silicone oil having a structure in which a part of methyl groups of the silicone oil is substituted by a carboxyl group or an alkyl group containing a hydroxide group.

2-2. Reactive Silicone Oil: Such as Amino, Epoxy, Carboxyl and Alcohol Substituted

Among them, preferably added is polyether modified silicone oil. The number average molecular weight of polyether modified silicone oil is, for example, 1,000-100,000 and preferably 2,000-50,000. Drying property of film is decreased when the number average molecular weight is less than 1,000, while there is a tendency of hardly causing bleed out on the film surface when the number average molecular weight is over 100,000.

Specific products include such as L-45, L-9300, FZ-3704, FZ-3703, FZ-3720, FZ-3786, FZ-3501, FZ-3504, FZ-3705, FZ-3707, FZ-3710, FZ-3750, FZ-3760, FZ-3785 and Y-7499 of Nippon Unicat Co., Ltd; and KF96L, KF96, KF96H, KF99, KF54, KF965, KF968, KF56, KF995, KF351, KF352, KF353, KF354, KF355, KF615, KF618, KF945, KF6004 and FL100 of Shin-Etsu Chemical Co., Ltd.

A silicone surfactant utilized in the present invention is a surfactant in which a part of methyl groups of silicone oil is substituted by a hydrophilic group. The positions of substitution are such as a side chain, the both ends, one end and the both terminal side chains. As a hydrophilic group, utilized are such as polyether, polyglycerin, pyrrolidone, betaine, sulfate, phosphate and quaternary salt.

As a silicone surfactant, preferable is a nonionic surfactant in which a hydrophobic group is constituted of dimethylpolysiloxane. and a hydrophilic group is constituted of polyalkylene.

A nonionic surfactant generally refers to a surfactant not provided with a group which dissociate in an aqueous solution, however, is provided with a hydroxyl group of polyhydric alcohols as a hydrophilic group in addition to a hydrophobic group, and further with such as a polyalkylene chain (polyoxyethylene) as a hydrophilic group. Hydrophilic property becomes strong as the number of an alcoholic hydroxyl group increases and as the polyoxyalkylene chain (polyoxyethylene chain) becomes long. A nonionic surfactant according to the present invention is characterized by having dimethylpolysiloxane as a hydrophobic group.

By utilizing a nonionic surfactant constituted of dimethylpolysiloxane as a hydrophobic group and polyoxyalkylene as a hydrophilic group, unevenness is decreased and antistaining property of the film surface is improved, with respect to the aforesaid low refractive index layer. A hydrophobic group comprising polysiloxane is oriented on the surface to make the film surface being hardly contaminated. This effect cannot be obtained by other surfactants.

Specific examples of these nonionic surfactants include such as silicone surfactants SILWET L-77, L-720, L-7001, L-7002, L-7604, Y-7006, FZ-2101, FZ-2104, FZ-2105, FZ-2110, FZ-2118, FZ-2120, FZ-2122, FZ-2123, FZ-2130, FZ-2154, FZ-2161, FZ-2162, FZ-2163, FZ-2164, FZ-2166 and FZ-2191, manufactured by Nippon Unicar Co., Ltd.

Further, listed are such as SUPERSILWET SS-2801, SS-2802, SS-2803, SS-2804 and SS-2805.

Further, a structure of a nonionic type surfactant, which is constituted of dimethylpolysiloxane as a hydrophobic group and polyoxyalkylene as a hydrophilic group, is preferably block copolymer of a straight chain form in which a dimethylpolysiloxane portion and a polyoxyethylene chain are alternately and repeatedly bonded. It is superior because of a long chain length of the primary chain skeleton and the straight chain form structure. It is considered because one surfactant can adsorb on the surface of a silica particle to cover said particle at plural portions since the surfactant is a block copolymer which is comprised of a hydrophilic group and a hydrophobic group alternately repeating.

Specific examples thereof include such as silicone surfactants ABN SILWET FZ-2203, FZ-2207 and FZ-2208, manufactured by Nippon Unicar Co., Ltd.

Among these silicone oil or silicone surfactants, those containing a polyether group are preferable.

Other surfactants may be utilized in combination, and appropriately utilized in combination are anionic surfactants of such as a sulfonate type, a sulfate ester type and a phosphate ester type; and nonionic surfactants of such as an ether type and an ether ester type which are provided with a polyoxyetylene chain as a hydrophilic group.

In the present invention, the above-described silicone oil or a silicone surfactant is preferably utilized in a layer adjacent to a low refractive index layer, specifically in a hard coat layer or a high refractive index layer. In the case of a low refractive index layer being the outermost surface layer of anti-reflection film, it is effective to improve scratch resistance of the surface in addition to enhancing water-repellency, oil-repellency and anti-staining property of the coated film. The content in coating solutions of a high refractive index layer and a low refractive index layer is preferably 0.05-2.0 weight %. Crack resistance is insufficient when the content is less than 0.05 weight %, while coating unevenness is caused when the content is over 2.0 weight %.

(Formation of Antireflection Layer)

In the present invention, a method to form an antireflection layer is not specifically limited; however, the layer is preferably formed by means of coating.

In the present invention, an antireflection layer is preferably manufactured by a process in which the aforesaid high refractive index layer composition and low refractive index layer composition are coated in this order on cellulose ester film having been provided with a hard coat layer.

Preferable constitutions of antireflection film will be shown in the following; however, they are not limited thereto.

Herein, a hard coat layer means the aforesaid ionizing radiation curable resin layer.

Transparent Substrate Film/Hard Coat Layer/High Refractive Index Layer/Low Refractive Index Layer

Transparent Substrate Film/Antistatic Layer/Hard Coat Layer/High Refractive Index Layer/Low Refractive Index Layer

Transparent Substrate Film/Anti-glare Hard Coat Layer/High Refractive Index Layer/Low Refractive Index Layer

Transparent Substrate Film/Antistatic Layer/Anti-glare Hard Coat Layer/High Refractive Index Layer/Low Refractive Index Layer

In any case, the aforesaid back coat layer is preferably provided on the surface of transparent substrate film opposite to the side on which a low refractive index layer is coated.

In the present invention, the surface of a hard coat layer is preferably subjected to a surface treatment after the hard coat layer have been formed, and a high refractive index layer and a low refractive index layer, according to the present invention, are preferably formed on the surface of the hard coat layer having been subjected to said surface treatment.

The reflectance of antireflection film according to the present invention can be measured by a spectrophotometer. At this time, the back surface of the measurement side of a sample is subjected to a light absorption treatment by use of a black colored spray after having been roughening treated, and reflective light in a visible light region (400-700 nm) is measured. The reflectance is preferably as low as possible, however, the mean reflectance in wavelengths of a visible light region is preferably not more than 1.5% and the minimum reflectance is preferably not more than 0.8%. Further, it is preferable to have a reflection spectrum of a flat shape in a visible light wavelength region.

Further, reflection hue of the polarizer plate surface having been subjected to an antireflection treatment is often approaches to red and blue because reflectance of shorter wavelengths and longer wavelengths in a visible light region is increased due to design of antireflection film, however, a desire with respect to a color tone of reflective light may differ depending on the application and a neutral tone is required in the case of being utilized on the outermost surface of such as a FPD television. In this case, a reflection hue range generally preferred is 0.17≦x≦0.27 and 0.07≦y≦0.17, on XYZ color specification system (CIE 1931 color specification system).

The layer thickness of a high refractive index layer and a low refractive index layer is determined by calculation according to an ordinary method in consideration of reflectance and a color tone of reflective light.

The surface treatment includes such as a washing method, an alkali treatment method, a flame plasma method, a high frequency discharge plasma method, an electron beam method, an ion beam method, a spattering method, an acid treatment method, a corona treatment method and an atmospheric pressure glow discharge plasma method. Preferable are an alkali treatment method and a corona treatment method, and specifically preferable is an alkali treatment method.

A corona treatment means a treatment in which a high voltage is applied between electrodes under an atmospheric pressure to perform discharge, and can be carried out by use of an apparatus available on the marked from such as Kasuga Electric Works Ltd. and Toyo Electric Works Ltd. Strength of a corona discharge treatment depends on a distance between electrodes, a power per unit area and a frequency of a generator. As one of the electrodes (A electrode) of a corona discharge treatment apparatus, those available on the market can be utilized, and the material can be selected from such as aluminum and stainless steel. The other is an electrode (B electrode) to hold plastic film, and is a roll electrode arranged at a constant distance against the aforesaid A electrode so as to stably and uniformly perform a corona treatment. This is also available on the market and a roll made of metal such as aluminum or stainless steel as the material, on which lining of such as ceramic, silicone, PET rubber and Hypalon rubber is applied, is preferably utilized. The frequency employed in a corona treatment of the present invention is 20-100 kHz and preferably 30-60 kHz. When the frequency decreases, uniformity of a corona treatment is deteriorated to generate unevenness of a corona treatment. While, when the frequency increases, it is not specifically problematic in the case of performing a high power corona treatment, however, it becomes difficult to perform a stable treatment resulting in generation of treatment unevenness in the case of performing a low power corona treatment. Power of a corona treatment is 1-5 W·min./m² and preferably 2-4 W·min./m². The distance between an electrode and film is 5-50 mm and preferably 10-35 mm. When the gap is increased, a high voltage is required to maintain a constant power resulting in easy generation of unevenness. While, the gap is excessively decreased, applied voltage becomes too small to easily cause unevenness. Further, film may touch the electrode, at the time of continuous treatment of film while being transported, to generate abrasion marks.

As an alkali treatment, it is not specifically limited provided that it is a method in which film having been coated with a hard coat layer is immersed in an alkaline aqueous solution.

As an alkaline aqueous solution, such as a sodium hydroxide aqueous solution, a potassium hydroxide aqueous solution and an ammonia aqueous solution can be utilized, and among them preferable is a sodium hydroxide aqueous solution.

Alkali concentration of an alkaline aqueous solution is 0.1-25 weight % and more preferably 0.5-15 weight %, for example, in the case of a sodium hydroxide aqueous solution.

The alkali treatment temperature is generally 10-80° C. and preferably 20-60° C.

The alkali treatment time is from 5 seconds to 5 minutes and preferably from 30 seconds to 3 minutes. Film after having been alkali treated is preferably neutralized with acid water followed by being sufficiently washed with water.

Each layer of an antireflection layer can be formed by means of coating utilizing a dip coat method, an air knife coat method, a curtain coat method, a roller coat method, a wire-bar coat method, a gravure coat method, a micro-gravure coat method or an extrusion coat method, on transparent substrate film. It is preferable that at the time of coating, transparent film is unwound from a state of being wound in a roll form having a width of 1.4-4 m, and the above-described coating and drying-curing treatment are performed, followed by being wound in a roll form.

Further, antireflection film of the present invention is preferably manufactured by a manufacturing method, in which, after the aforesaid optical interference layer is accumulated on transparent substrate film, the resulting film, being wound in a roll form, is thermally treated at a range of 50-150° C. and for 1-30 days. The thermal treatment temperature is preferably 50-120° C. The term of thermal treatment is suitably determined depending on the set temperature, and, for example, is preferably 3-30 days at 50° C. and 1-3 days at 150° C. Prior to thermal treatment, the both edges of film are preferably subjected to an embossing treatment.

To stably perform thermal treatment, the treatment is required to be performed in a place where temperature and humidity are controllable, and is preferably performed in a thermal treatment room such as a clean room without dust.

A take-up core, at the time of winding up optical film, on which functional thin film has been coated, in a roll form, may be one formed of any material provided that it is a cylindrical core, however, is preferably a hollow plastic core. Any plastic material can be utilized provided that it is heat resistant plastic durable against the thermal treatment temperature, and listed are such as phenol resin, xylene resin, melamine resin, polyester resin and epoxy resin. Further, preferable is heat curing resin which is reinforced by a filling material such as glass fiber.

The winding number of this film is preferably not less than 100 and more preferably not less than 500, and the winding thickness is preferably not less than 5 cm.

When a roll, which is a plastic film substrate of a long roll having been coated with a functional layer in this manner and wound around a plastic core, is subjected to the aforesaid thermal treatment in a state of being wound up, said roll is preferably rotated and the rotation is preferably performed at a rate of not more than 1 rotation per 1 minute, either continuously or intermittently. Further, rewinding of said roll is preferably performed not less than 1 time during the heating period.

To rotate a long length optical film roll wound up on a core during a thermal treatment, it is preferable to provide an exclusive rotation table in a thermal treatment room.

Stopping time is preferably set within 10 hours when the rotation is intermittent, the stop position being preferably made uniform along the circumference direction, and stopping time is more preferably within 10 minutes. Most preferable mode is continuous rotation.

Rotation rate of continuous rotation is preferably not longer than 10 hours based on time required for one rotation, and is practically in a range of essentially from 15 minute to 2 hours since excessively fast rotation rate is disadvantageous to an apparatus.

Herein, an exclusive wagon having a rotating function is preferable because an optical film roll can be rotated also during transportation and storage, and in this case, rotation functions effective to prevent a black band which may be caused during long term storage.

<Polarizing Plates>

The polarizing plates of the present invention will be described.

The polarizing plate of the present invention can be prepared by employing a common method. For example, the reverse side of the antireflection film of the present invention, where the antireflection layer is not provided, is subjected to an alkali saponification treatment, while a polarizing film is prepared by stretching a polyvinyl alcohol film immersed in an iodine aqueous solution. A polarizing plate is prepared by adhering the above alkali saponified surface of the antireflection film onto one surface of the above polarizing film using an aqueous solution of completely-saponified polyvinyl alcohol as an adhesive. The antireflection film of the present invention or another polarizing plate protective film may be provided on the other surface of the polarizing film. The polarizing plate protective film to be used on the surface opposite to the antireflection film is preferably a optical compensation film (a retardation film)having an in-plane retardation value Ro of 20-70 nm at a wavelength of 590 nm, and Rt of 100-400 nm. Such optical compensation film is prepared by the method disclosed in, for example, JP-A No. 2002-71957 or Japanese Patent Application No. 2002-155395 (JP-A No. 2003-170492). As the polarizing plate protective film, also preferably employed is a film which also works as an optical compensation film having an optically anisotropic layer in which a liquid crystalline compound, for example, discotic liquid crystalline compound, is oriented. An optically anisotropic layer can be prepared by a method disclosed, for example, in JP-A 2003-98348. In combination of the polarizing plate with the antireflection film of the present invention, a polarizing plate exhibiting excellent flatness and improved viewing angle is obtained.

Examples of a polarizing plate protective film employed on the other surface include commercially available cellulose ester films, for example, KC8UX2MW, KC4UX, KC5Ux, KC4UY, KC8UY, KC12UR, KV8UCR-3, KC8UCR-4 and KC8UCR-5 (all produced by Konica Minolta Opt, Inc.).

The polarizing film which is a major constituting component of polarizing plates, as described herein, refers to the element which only transmits the light of a polarized wave in the definite direction. The representative polarizing film, which is presently known, is a polyvinyl alcohol based polarizing film which is classified to one prepared by dying polyvinyl alcohol based film with iodine and the other prepared by dying the same with dichroic dyes, however, the polarizing film is not limited thereto. The polarizing film is prepared in such a manner that an aqueous polyvinyl alcohol solution is cast into a film and the resulting cast film is subjected to uniaxially stretching followed by dying, or is subjected to dying followed by uniaxially stretching, and, preferably, the resulting film is subjected to a durability treatment employing a boron compound. The thickness of the polarizing film is preferably 5-30 μm, and more preferably 8 15 μm. One side of the antireflection film of the present invention is adhered to the surface of the above polarizing film to form a polarizing plate. Adhesion is preferably performed employing water-soluble adhesives containing completely-saponified polyvinyl alcohol.

(Display)

By providing the antireflection film of the present invention on the observation side surface of a display, it is possible to prepare various displays of the present invention, which exhibit excellent visibility. The antireflection film of the present invention is preferably employed in a reflection type, transmission type, and a semi-transmission type LCDs or LCDs of various driving systems such as a TN type, an STN type, an OCB type an HAN type, a VA type (a PVA type and an MVA type) and an IPS type. Further, the antireflection film of the present invention exhibits notably reduced color unevenness in reflected light, low reflectivity and excellent flatness, and is preferably employed to various displays, for example, a plasma display, a field emission display, an organic EL display, an inorganic. EL display and an electronic paper. Specifically, in a large screen display device, color unevenness and wavy unevenness were minimized, resulting in obtaining effects of reducing eye fatigue even for viewing of an extended period.

### EXAMPLES

The present invention will further be explained using the following examples, however, the present invention is not limited thereto.

<Preparation of Dope>

The following material were loaded in turn and sealed in a container and the temperature was raised from 20° C. to 80° C. The loaded materials were stirred in the container at 80° C. for three hours, whereby the cellulose ester was completely dissolved. Silicon dioxide particles were added by preliminary dispersing the particles in a liquid containing a solvent to be used and a small amount of cellulose ester. Obtained liquid was filtered using Filter Paper No. 244 produced by Azumi Filter Paper Co., Ltd. to obtain Dope A.

(Preparation of Dope A)

Cellulose ester (cellulose triacetate; the acetylation degree of 2.9) 100 weight parts

Trimethylolpropane tribenzoate 5 weight parts

Ethylphthalylethyl glycolate 5 weight parts

Silica particles (Aerosil R972V produced by Nippon Aerosil Co., Ltd.) 0.1 weight parts

Methylene chloride 300 weight parts

Ethanol 40 weight parts

(Preparation of Dope B)

Dope B was prepared in the same manner as Dope A except that the materials were changed as follows:

Cellulose ester (cellulose triacetate; the acetylation degree of 2.8) 100 weight parts

Triphenyl phosphate 10 weight parts

Biphenyldiphenyl phosphate 2 weight parts

Silica particles (Aerosil R972V produced by Nippon Aerosil Co., Ltd.) 0.1 weight parts

Methyl acetate 300 weight parts

Ethanol 80 weight parts.

The dope prepared as above was cast through a casting die kept at 30° C. on a stainless steel endless support kept at 30° C. After the formed web was dried until the amount of residual solvent decreased to 80% by weight, the web was peeled from the support using a peeling roller.

Subsequently, the web was dried in an 70° C. air flow by passing through many rollers placed alternatively up and down in a staggered manner, then the both edges of the web were clipped with a tenter and stretched by 1.1 times in the lateral direction at 130° C. The stretched web was further dried in an 105° C. air flow to obtain a film containing residual solvent of 0.3% by weight. The obtained film was heat treated for 15 minutes under a condition of prescribed temperature and rate of atmosphere replacement, then, cooled to ambient temperature and wound in a roller to obtain a long roll cellulose ester film having the following features: thickness of 80 μm, length of 1000 m, and refractive index of 1.49. The stretch ratio of the web just after peeled from the support estimated from the rotation rate of the support and driving rate of the tenter was 1.1 times. Thus Film 1 was obtained.

Films 2-5 were produced in the same manner as Film 1, except that the kind of dope, treatment temperature after the web was dried and atmosphere replacement rate were changed as shown in Table 1.

The atmosphere replacement rate is the number of times replacing the atmosphere of a heat treatment chamber by fresh-air per unit time, provided that the volume of the heat treatment chamber is expressed as V (m³) and the amount of fresh-air sent to the heat treatment chamber is expressed as FA (m³/h).
Atmosphere replacement rate=FA/V(times/h)

TABLE 1

| Cellulose | | Heat | Atmosphere | | | | | Free | Total |
|---|---|---|---|---|---|---|---|---|---|
| ester | | Treatment | Replacement | pressurizing | Stretching | Stretching | | volume | free |
| film | | Temperature | rate | treatment | Temperature | ratio | | radius | volume |
| No. | Dope | (° C.) | (times/h) | (kPa) | (° C.) | MD | TD | (nm) | parameter |
| 1 | A | 105 | 12 | — | 130 | 1.1 | 1.1 | 0.310 | 2.0 |
| 2 | A | 125 | 15 | 1 | 130 | 1.1 | 1.1 | 0.285 | 1.4 |
| 3 | A | 135 | 25 | 10 | 130 | 1.1 | 1.1 | 0.250 | 1.0 |
| 4 | A | 100 | 15 | — | 130 | 1.1 | 1.1 | 0.315 | 2.2 |
| 5 | B | 135 | 25 | 3 | 130 | 1.1 | 1.1 | 0.300 | 1.6 |

(Production of Antireflection Film)

Antireflection films were produced in the following manner using the cellulose ester films produced as described above.

The refractive index of each constituting layer of the antireflection film was measured according to the following method.

(Refractive Index)

The refractive index of each refractive index layer was measured by applying each layer alone on a hard coat film, using a spectroscopic reflectivity determined by a spectrophotometer. A spectrophotometer U-4000 produced by Hitachi Ltd. was used for the measurement. The rear surf ace of each sample was subjected to a roughening treatment followed by a light absorption treatment by applying a black spray in order to prevent reflection of light on the rear surface. The specular reflectance at an incidence angle of 50 was measure using visible rays in the range of 400-700 nm.

(Particle Diameter of Metal Oxide Particles)

Particle diameter of metal oxide primary particles was determined by observing 100 particles with a transmission electron microscope (TEM). An average diameter of circumscribing circles of the 100 particles was designated as the average diameter of the particles.

<<Production of Cellulose Ester Film Provided With Hard Coat Layer and Back Coat Layer>>

On each cellulose ester film described in Table 1, the following hard coat layer-coating liquid 1 which was filtered using a polypropylene filter having 0.4 μm pores was applied using a micro-gravure coater. The film was dried at 90° C. and then the hard coat layer was hardened by irradiating 0.1 J/cm² of UV rays from an UV lamp of which illuminance at the illumination area is 100 mW/cm² to form hard coat layer 1. having a dry thickness of 7 μm.

(Hard Coat Layer Coating Liquid 1)

The following materials were mixed while stirring to obtain hard coat layer coating liquid 1.

Acrylic monomer; KAYARAD DPHA (dipentaerythritol hexaacrylate, produced by NIPPON KAYAKU CO., LTD.)
220 weight parts

Irgacure 184 (produced by CIBA SPECIALTY CHEMICALS INC.) 20 weight parts

Propylene glycol monomethyl ether
110 weight parts

Ethyl acetate 110 weight parts

Furthermore, the following back coat layer coating composition was coated by an extrusion coater on the rear surface so that 10 μm of wet thickness was obtained, and dried at 85° C. and wound in a roll to form a back coat layer.

(Back Coat Layer Coating Composition)

Acetone 54 weight parts

Methylethyl ketone 24 weight parts

Methanol 22 weight parts

Diacetyl cellulose 0.6 weight part

Silica particles 2% acetone dispersion (Aerosil 200V produced by. Nippon Aerosil Co., Ltd.)0.2 weight part

Similarly, hard coated films 2-25 were produced by changing the thickness of the hard court layer as shown in Table 2.

<<Production of Antireflection Film>>

Antireflection films were produced by applying, on each had coat film, a high refractive index layer and a low refractive index layer in that order.
<<Production of Antireflection Layer: High Refractive Index Layer>>

On the hard coated film, the following high refractive index layer coating composition 1 was coated by an extrusion coater and dried at 80° C. for 1 minute, followed by being irradiated with 0.1 J/cm² of UV rays to harden the layer. The layer was further heat cured at 100° C. for 1 minute to obtain high refractive index layer 1-25 having a thickness of 78nm.

The refractive index of the high refractive index layer 1 was 1.62.

<High Refractive Index Layer Coating Composition 1>

(a) Isopropyl alcohol dispersion of metal oxide particles (solid content: 20%, ITO particles, average primary particle diameter: 50 nm) 55 weight parts

(b) Metal compound: Ti(OBu)₄ (titanium tetra-n-butoxide) 1.3 weight parts

(c) Ionizing radiation curable resin: dipentaerythritol hexaacrylate 3.2 weight parts

Photopolymerization initiator: irugacure 184 (produced by CIBA SPECIALTY CHEMICALS INC.) 0.8 weight part

(d) 10% propylene glycol monomethyl ether liquid of normal-chain dimethyl silicone-EO block copolymer (FZ-2207, Nippon Unicar Co., Ltd.) 1.5 weight parts

Propylene glycol monomethyl ether
120 weight parts

Isopropyl alcohol 240 weight parts

Methyl ethyl ketone 40 weight parts

<<Production of Antireflection Layer: Low Refractive Index Layer>>

On each high refractive index layer, the following low refractive index layer coating composition 1 was coated by an extrusion coater and dried at 100° C. for 1 minute, followed by being irradiated with 0.1 J/cm²of UV rays to harden the layer. The layer was further heat cured at 120° C. for 5 minute. The layer thickness was 95 nm. Thus, antireflection films 1-25 as shown in Table 2 were obtained.

<Low Refractive Index Layer Coating Composition 1>

<Preparation of Hydrolyzed Tetraethoxysilane A>

In a mixture of 289 g of tetraethoxysilane and 553 g of ethanol, 157 g of 0.15% acetic acid aqueous solution was added, and stirred for 30 hours over a 25° C. water bath to obtain hydrolyzed tetraethoxysilane A.

(e) Hydrolyzed tetraethoxysilane A
110 weight parts

(f) Hollow silica particles (P-2: described below)
30 weight parts

KBM503 (a silane coupling agent, produced by Shin-Etsu Chemical Co., Ltd.) 4 weight parts

(g) 10% propylene glycol monomethyl ether liquid of linear dimethyl silicone-EO block copolymer (FZ-2207, Nippon Unicar Co., Ltd.) 3 weight parts

Propylene glycol monomethyl ether
400 weight parts

Isopropyl alcohol 400 weight parts

<Preparation of Hollow Silica Particles P-2>

A mixture of 100 g of silica sol containing 20% by weight of SiO₂ (average particle diameter: 5 nm) and 1900 g of pure water was heated to 80° C. The pH of the liquid was 10.5. In this liquid, 9000 g of 0.98% by weight sodium silicate aqueous solution and 9000 g of 1.02% by weight (as Al₂O₃) of sodium aluminate aqueous solutions were simultaneously added while keeping the liquid temperature at 80° C. The pH of the liquid increased to 12.5 just after the aqueous solutions were added and then kept almost constant. Then, the liquid was cooled to ambient temperature and the solid component was washed by using a ultra filter membrane followed by preparing a SiO₂.Al₂O₃ core particles dispersion liquid having solid content of 20% by. weight (process (a)).

To 500 g of the SiO₂.Al₂O₃ core particles dispersion liquid, 1700 g of pure water was added and heated to 98° C. Further added was 3000 g of silicate solution prepared by dealkalization of sodium silicate aqueous solution with cation exchange resin to obtain a dispersed liquid of the core particles coated with a first silica coat layer, while the liquid temperature was kept constant (process (b)).

Subsequently, to 500 g of the dispersion liquid of core particles coated with the first silica layer, of which solid content was 13% by weight as a result of washing using a ultrafilter membrane, 1125 g of pure water was added and a conk hydrochloric acid (35.5%) was dripped to adjust the pH to 1.0, whereby partial dealuminization of SiO₂.Al₂O₃ core particles was carried out. Dissolved aluminum salt was removed using an ultrafilter membrane while adding 10 liter of pH 3 hydrochloric acid and 5 liter of pure water, whereby obtained was a dispersion liquid of porous SiO₂.Al₂O₃ core particles coated with the first silica layer, from which a part of constituting component was removed (process (c)). A mixture of 1500 g of the above described dispersion liquid of porous particles, 500 g of pure water, 750 g of ethanol and 626 g of 28% aqueous ammonia was heated to 35° C. and 104 g of ethyl silicate solution (SiO₂: 28% by weight) was added to form a second silica coat layer containing hydrolyzed and polycondensed silica on each porous particle coated with the first silica coat layer. By exchanging the solvent from water to ethanol using an ultrafilter membrane, a dispersion liquid of hollow silica particles having a solid content of 20% by weight (P-2) was prepared.

The hollow silica particles had the first silica coat layer thickness of 3 nm, the mean particle diameter of 47 nm, Mox/SiO2 ratio (in mole) of 0.0017 and the refractive index of 1.28. The mean particle diameter was determined using a dynamic light scattering method.

<<Heat Treatment of Antireflection Film>>

Each of antireflection films 1-25 (length: 1000 m) was wound to a plastic core and was subjected to a heat treatment for 4 days at 80° C. in a heat treatment chamber.

TABLE 2

| | Hard | Hard coat | Cellulose | Scratch | | | | |
|---|---|---|---|---|---|---|---|---|
| Antireflection | coat | film | ester | resistance | | | | |
| Film | film | thickness | film | (scratchs/ | Crack | Pencil | | |
| No. | No. | (μm) | No. | cm) | resistance | hardness | Flatness | Remarks |
| 1 | 1 | 7 | 1 | 10 | A | 2-3H | C | Comp. |
| 2 | 2 | 8 | 1 | 2 | A | 4H | A | Inv. |
| 3 | 3 | 10 | 1 | 2 | A | 4H | A | Inv. |
| 4 | 4 | 20 | 1 | 2 | A | 4H | A | Inv. |
| 5 | 5 | 21 | 1 | 9 | B | 4H | D | Comp. |
| 6 | 6 | 7 | 2 | 9 | A | 2-3H | C | Comp. |
| 7 | 7 | 8 | 2 | 2 | A | 4H | A | Inv. |
| 8 | 8 | 16 | 2 | 2 | A | 4H | A | Inv. |
| 9 | 9 | 20 | 2 | 2 | A | 4H | A | Inv. |
| 10 | 10 | 21 | 2 | 9 | B | 4H | D | Comp. |
| 11 | 11 | 7 | 3 | 9 | A | 2-3H | C | Comp. |
| 12 | 12 | 8 | 3 | 2 | A | 4H | A | Inv. |
| 13 | 13 | 16 | 3 | 2 | A | 4H | A | Inv. |
| 14 | 14 | 20 | 3 | 2 | A | 4H | A | Inv. |
| 15 | 15 | 21 | 3 | 9 | A | 4H | D | Comp. |
| 16 | 16 | 7 | 4 | 12 | B | 2-3H | C | Comp. |
| 17 | 17 | 8 | 4 | 2 | B | 4H | C | Inv. |
| 18 | 18 | 16 | 4 | 2 | B | 4H | C | Inv. |
| 19 | 19 | 20 | 4 | 2 | B | 4H | C | Inv. |
| 20 | 20 | 21 | 4 | 10 | B | 4H | D | Comp. |
| 21 | 21 | 7 | 5 | 9 | A | 2-3H | C | Comp. |
| 22 | 22 | 8 | 5 | 3 | A | 3H | B | Inv. |
| 23 | 23 | 16 | 5 | 3 | A | 3H | B | Inv. |
| 24 | 24 | 20 | 5 | 3 | A | 3H | B | Inv. |
| 25 | 25 | 21 | 5 | 9 | B | 3H | D | Comp. |

Inv.: Inventive sample,
Comp.: Comparative sample

<<Evaluation>>

Each antireflection film was evaluated as described below. The results were summarized in Table 2.

(Reflectance)

Using a spectrophotometer U-4000 produced by Hitachi Ltd., spectroscopic reflectance at an incidence angle of 5° in the wavelength range of 380-780 nm was measured. To obtain a desirable antireflective property, the reflectivity is preferably small in a wide wavelength range. Accordingly, the lowest reflectivity in the wavelength range of 450-650 nm was obtained. The rear surface of each sample was subjected to a roughening treatment followed by a light absorption treatment by applying a black spray in order to prevent reflection of light on the rear surface.

The reflectance of each of the antireflection films 1-25 was 0.4%.

(Pencil Hardness)

According to the method of JIS K 5600 (identical with ISO 15184:96), the sample surface was scratched with a pencil of known hardness with a load of 1 kg using a pencil hardness tester (Clemens type Scratch Hardness Tester: HA-301, produced by TESTER SANGYO CO., LTD.). Presence of scratch mark on the sample was visually observed. When scratch marks were observed on two or more samples in scratching tests with a 3H pencil on 5 samples while a scratch mark was observed on only one sample or less in scratching tests with a 2H pencil on also 5 samples, the hardness of the sample was evaluated as 2H.

(Scratch Resistance)

Under a condition of 23° C. and 55% RH, a load of 300 kg/cm² was applied on #0000 steel wool (SW) and 10 times shuttled on the sample. Number of scratch marks in a width of 1 cm was measured. The number was measured at a portion where it was the largest. When the number is 10 scratch marks/cm, the antireflection film is suitable for practical use, however, it is preferably 5 scratch marks/cm or less and more preferably 3 scratch marks/cm or less.

(Crack)

Each sample was heat treated at 90° C. for 500 hours and observed by using a microscope (magnification of 20). The results were evaluated according to the following criteria.

A: No crack was observed

B: Slight cracks were partially observed

C: Cracks were observed all over the surface

<<Flatness: Visual Observation>>

Each sample was cut into a sheet of a width of 90 cm and a length of 100 cm and placed on a stage. Five 50 W fluorescent tubes were placed 1.5 m above the stage so that the fluorescent tubes illuminate the stage from an angle of 45°. The images of the fluorescent tubes reflected by the antireflection film sample were observed to evaluate the concavity and convexity of the film. The evaluation criteria were as follows. Wrinkle of the film can be evaluated by this method.

A: Fluorescent tubes looks straight

B: Fluorescent tubes looks partially bending

C: Fluorescent tubes looks totally slightly bedding

D: Fluorescent tubes looks largely undulated

The results shown in Table 2 revealed that the antireflection films having the hard coat layer thickness within the range of the present invention exhibited scratch resistance, pencil hardness, crack resistance and flatness, which were superior to those of the comparative examples.

The cellulose ester films exhibiting free volume radius determined by positron annihilation lifetime spectroscopy of 0.250-0.310 nm showed totally preferable properties in scratch resistance, pencil hardness, crack resistance and flatness.

### Example 2

Using hard coat films 3 and 16 produced in example 1, antireflection films were prepared as described below.

<<Production of Antireflection Layer: High Refractive Index Layer>>

High refractive index layers 2-1 to 2-27 were produced in the same manner as high refractive index layer 1 except that the metal oxide particles, metal compound, ionizing radiation curable resin and surfactant used in high refractive index layer coating composition 1 were changed as shown in Table 3.

<<Production of Antireflection Layer: Low refractive Index Layer>>

On each of the high refractive index layer 2-1 to 2-27, low refractive index layer coating composition 1 used in example 1 was applied by an extrusion coater and dried at 100° C. for 1 minute, followed by being irradiated with 0.1 J/cm² of UV rays to harden the layer. The layer was further heat cured at 120° C. for 5 minute. The layer thickness was 95 nm. Thus, antireflection films 26-56 as shown in Table 4 were obtained.

<<Heat Treatment of Antireflection Film>>

Each of antireflection films 26-53 (length: 1000 m) was wound to a plastic core and was subjected to a heat treatment for 4 days at 80° C. in a heat treatment chamber.

Using antireflection film 30, antireflection films 54-56 were produced by heat treating under the conditions shown in Table 4.

Obtained antireflection films were evaluated as in example 1 and further as described below. The reflectance of each antireflection film was 0.4%.

<<Evaluation>>

(UV Resistance)

UV irradiation was carried out using EYE SUPER UV TESTER (SUV-F11, produced by IWASAKI ELECTRIC CO., LTD.). While UV rays were irradiated, in every 20 hours, the samples were subjected to an adherence test to find out the time when the layer began to peel. The adherence test was carried out according to the crosscutting method of JIS K5400. When the time is 50 hours or more, the antireflection film is suitable for practical use, however, more preferably 100 hours or more and still more preferably 200 hours or more.

(Haze)

Three sheets of samples were superposed, and haze of the resulting materials was measured employing T-2600DA available from Tokyo Denshoku Co., Ltd. When the haze is 2.0% or less, the antireflection film is suitable for practical use, however, more preferable is 1.0% or less.

TABLE 3

| | | Diameter | | (c) | | | | | |
|---|---|---|---|---|---|---|---|---|---|
| High | (a) Metal | of metal | | Ionizing | | | | | |
| refractive | oxide | oxide | (b) Metal | radiation | | | (f) | | |
| index layer | particles | particles | compound *1 | curable | | | Surfactant | Refractive | |
| No. | (wt %) | (nm) | (wt %) | resin (wt %) | *2 | *3 | (wt %) | index | Remarks |
| 2-1 | ITO (71) | 5 | Ti(OBu)₄ (2) | DPHA (26) | 80:20 | 1:13 | FZ2207 (1) | 1.62 | Comp. |
| 2-2 | ITO (71) | 10 | Ti(OBu)₄ (2) | DPHA (26) | 80:20 | 1:13 | FZ2207 (1) | 1.62 | Inv. |
| 2-3 | ITO (71) | 40 | Ti(OBu)₄ (2) | DPHA (26) | 80:20 | 1:13 | FZ2207 (1) | 1.62 | Inv. |
| 2-4 | ITO (71) | 70 | Ti(OBu)₄ (2) | DPHA (26) | 80:20 | 1:13 | FZ2207 (1) | 1.62 | Inv. |
| 2-5 | ITO (71) | 140 | Ti(OBu)₄ (2) | DPHA (26) | 80:20 | 1:13 | FZ2207 (1) | 1.62 | Inv. |
| 2-6 | ITO (71) | 200 | Ti(OBu)₄ (2) | DPHA (26) | 80:20 | 1:13 | FZ2207 (1) | 1.62 | Inv. |
| 2-7 | ITO (71) | 210 | Ti(OBu)₄ (2) | DPHA (26) | 80:20 | 1:13 | FZ2207 (1) | 1.62 | Comp. |
| 2-8 | ATO (71) | 70 | Ti(OBu)₄ (2) | DPHA (26) | 80:20 | 1:13 | FZ2207 (1) | 1.62 | Inv. |
| 2-9 | ZrO₂ (71) | 70 | Ti(OBu)₄ (2) | DPHA (26) | 80:20 | 1:13 | FZ2207 (1) | 1.62 | Inv. |
| 2-10 | Sb₂O₅ (71) | 70 | Ti(OBu)₄ (2) | DPHA (26) | 80:20 | 1:13 | FZ2207 (1) | 1.62 | Inv. |
| 2-11 | SnO₂ (71) | 70 | Ti(OBu)₄ (2) | DPHA (26) | 80:20 | 1:13 | FZ2207 (1) | 1.62 | Inv. |
| 2-12 | ZnO (71) | 70 | Ti(OBu)₄ (2) | DPHA (26) | 80:20 | 1:13 | FZ2207 (1) | 1.62 | Inv. |
| 2-13 | ZnSb₂O₆ (71) | 70 | Ti(OBu)₄ (2) | DPHA (26) | 80:20 | 1:13 | FZ2207 (1) | 1.62 | Inv. |
| 2-14 | ITO (71) | 70 | Ti(OBu)₄ (2) | DPHA (26) | 80:20 | 1:13 | FZ2207 (1) | 1.62 | Inv. |
| 2-15 | ITO (71) | 70 | Ti(acac) (2) | DPHA (26) | 80:20 | 1:13 | FZ2207 (1) | 1.62 | Inv. |
| 2-16 | ITO (73) | 70 | — | DPHA (26) | 80:20 | — | FZ2207 (1) | 1.62 | Comp. |
| 2-17 | ITO (74.7) | 70 | Ti(OBu)₄ (0.3) | DPHA (24) | 80:20 | 1:80 | FZ2207 (1) | 1.63 | Inv. |
| 2-18 | ITO (79) | 70 | Ti(OBu)₄ (5) | DPHA (15) | 80:20 | 1:3 | FZ2207 (1) | 1.64 | Inv. |
| 2-19 | ITO (74.5) | 70 | Ti(OBu)₄ (7) | DPHA (17.5) | 80:20 | 1:2.5 | FZ2207 (1) | 1.63 | Inv. |
| 2-20 | ITO (71) | 70 | Ti(OBu)₄ (2) | *4 (26) | 80:20 | 1:13 | FZ2207 (1) | 1.62 | Inv. |
| 2-21 | ITO (71) | 70 | Ti(OBu)₄ (2) | DPHA (26) | 95:5 | 1:13 | FZ2207 (1) | 1.62 | Inv. |
| 2-22 | ITO (71) | 70 | Ti(OBu)₄ (2) | DPHA (26) | 90:10 | 1:13 | FZ2207 (1) | 1.62 | Inv. |
| 2-23 | ITO (71) | 70 | Ti(OBu)₄ (2) | DPHA (26) | 70:30 | 1:13 | FZ2207 (1) | 1.62 | Inv. |
| 2-24 | ITO (71) | 70 | Ti(OBu)₄ (2) | DPHA (26) | 65:35 | 1:13 | FZ2207 (1) | 1.62 | Inv. |
| 2-25 | ITO (68.7) | 70 | Ti(OBu)₄ | DPHA (30) | 80:20 | 1:100 | FZ2207 (1) | 1.62 | Inv. |
| | | | (0.3) | | | | | | |
| 2-26 | ITO (65.7) | 70 | Ti(OBu)₄ | DPHA (33) | 80:20 | 1:110 | FZ2207 (1) | 1.61 | Inv. |
| | | | (0.3) | | | | | | |
| 2-27 | ITO (71) | 70 | Ti(OBu)₄ (2) | DPHA (26) | 80:20 | 1:13 | MEGAFAC F- | 1.62 | Inv. |
| | | | | | | | 470 (1) | | |

Each value in parentheses in columns of above (a), (b), (c) and (f) represents weight content of respective compound in the high refractive index layer, expressed by % by weight.
Inv.: Inventive example,
Comp.: Comparative example,
*1: Each weight content is expressed as a weight content of equivalent metal oxide (e.g., Ti(OBu)₄ → TiO₂, Ti(AcAc) → TiO₂).
*2: weight ratio of acryl compound in the ionizing radiation curable resin to photopolymerization initiator (Irgacure 184).
*3: weight ratio of equivqlent metal oxide based of the metal compound to ionizing radiation curable resin, namely, (b):(c).
*4: DPHA:DPPA:DPTA = 60:20:20 (in weight ratio) where DPHA: dipentaerythritol hexaacrylate, DPPA: dipentaerythritol pentaacrylate, DPTA: dipentaerythritol tetraacrylate.
Further, Ti(OBu)₄: titanium tetra-n-butoxide, Zr(OBu)₄: zirconium tetra-n-butoxide, Ti(acac): titanium diacetylacetonate di-iso-propylate, FZ2207: linear dimethyl silicone-EO block copolymer (FZ-2207, Nippon Unicar Co., Ltd.) and
MEGAFAC F-470: origomer containing perfluoroalkyl group (Dainippon Ink and Chemicals, Inc.).

TABLE 4

| | | High | Low | | | | | | | | |
|---|---|---|---|---|---|---|---|---|---|---|---|
| | Hard | refractive | refractive | | Scratch | | | | | | |
| Antireflection | coat | index | index | | resistance | | | | | | |
| film | film | layer | layer | Heat | (scratchs/ | Crack | Pencil | UV | Haze | | |
| No. | No. | No. | No. | treatment | cm) | resistance | hardness | resistance | (%) | Flatness | Remarks |
| 26 | 16 | 2-4 | 1 | *1 | 10 | B | 2-3H | 80 | 0.9 | C | Comp. |
| 27 | 3 | 2-1 | 1 | *1 | 9 | A | 3-4H | 40 | 0.9 | B | Comp. |
| 28 | 3 | 2-2 | 1 | *1 | 2 | A | 4H | 60 | 0.9 | A | Inv. |
| 29 | 3 | 2-3 | 1 | *1 | 2 | A | 4H | 80 | 0.9 | A | Inv. |
| 30 | 3 | 2-4 | 1 | *1 | 2 | A | 4H | 100 | 0.9 | A | Inv. |
| 31 | 3 | 2-5 | 1 | *1 | 2 | A | 4H | 100 | 1.1 | A | Inv. |
| 32 | 3 | 2-6 | 1 | *1 | 2 | A | 4H | 140 | 1.3 | B | Inv. |
| 33 | 3 | 2-7 | 1 | *1 | 9 | B | 3-4H | 160 | 2.1 | C | Comp. |
| 34 | 3 | 2-8 | 1 | *1 | 2 | A | 4H | 100 | 0.9 | A | Inv. |
| 35 | 3 | 2-9 | 1 | *1 | 2 | A | 4H | 100 | 0.9 | A | Inv. |
| 36 | 3 | 2-10 | 1 | *1 | 2 | A | 4H | 100 | 0.9 | A | Inv. |
| 37 | 3 | 2-11 | 1 | *1 | 2 | A | 4H | 100 | 0.9 | A | Inv. |
| 38 | 3 | 2-12 | 1 | *1 | 2 | A | 4H | 100 | 0.9 | A | Inv. |
| 39 | 3 | 2-13 | 1 | *1 | 2 | A | 4H | 100 | 0.9 | A | Inv. |
| 40 | 3 | 2-14 | 1 | *1 | 2 | A | 4H | 100 | 0.9 | A | Inv. |
| 41 | 3 | 2-15 | 1 | *1 | 2 | A | 4H | 100 | 0.9 | A | Inv. |
| 42 | 3 | 2-16 | 1 | *1 | 27 | C | 3-4H | 60 | 0.9 | B | Comp. |
| 43 | 3 | 2-17 | 1 | *1 | 3 | A | 4H | 140 | 0.9 | B | Inv. |
| 44 | 3 | 2-18 | 1 | *1 | 2 | A | 4H | 80 | 0.9 | A | Inv. |
| 45 | 3 | 2-19 | 1 | *1 | 2 | A | 4H | 60 | 0.9 | A | Inv. |
| 46 | 3 | 2-20 | 1 | *1 | 2 | A | 4H | 100 | 0.9 | A | Inv. |
| 47 | 3 | 2-21 | 1 | *1 | 3 | A | 4H | 140 | 0.9 | B | Inv. |
| 48 | 3 | 2-22 | 1 | *1 | 3 | A | 4H | 80 | 0.9 | B | Inv. |
| 49 | 3 | 2-23 | 1 | *1 | 2 | A | 4H | 80 | 0.9 | A | Inv. |
| 50 | 3 | 2-24 | 1 | *1 | 2 | A | 4H | 60 | 0.9 | A | Inv. |
| 51 | 3 | 2-25 | 1 | *1 | 3 | A | 4H | 160 | 0.9 | B | Inv. |
| 52 | 3 | 2-26 | 1 | *1 | 3 | A | 4H | 160 | 0.9 | B | Inv. |
| 53 | 3 | 2-27 | 1 | *1 | 2 | A | 4H | 100 | 0.9 | A | Inv. |
| 54 | 3 | 2-4 | 1 | *2 | 7 | B | 3H | 100 | 0.9 | A | Inv. |
| 55 | 3 | 2-4 | 1 | *3 | 3 | A | 4H | 100 | 0.9 | B | Inv. |
| 56 | 3 | 2-4 | 1 | *4 | 2 | A | 4H | 100 | 0.9 | B | Inv. |

Inv.: Inventive example,
Comp.: Comparative example,
*1: 80° C., 4 days,
*2: 60° C., 12 hours,
*3: 60° C., 14 days,
*4: 120° C., 1 day

The results shown in Table 4 revealed that: (i) the antireflection film of the present invention containing a transparent substrate film having thereon a hard coat layer of which the thickness is 8-20 μm, a high refractive index layer and a low refractive index layer of the present invention, the antireflection film being subjected to a heat treatment, exhibited an excellent scratch resistance and pencil hardness; and (ii) the antireflection film of the present invention having a free volume radius determined by positron annihilation lifetime spectroscopy in the prescribed range and a hard coat layer of which thickness is 8-20 μm exhibited reduced deterioration of flatness due to a heat treatment and exhibited an excellent flatness.

### Example 3

Using antireflection films 1-56 produced in examples 1 and 2, polarizing plates were produced as described below, each of which was installed in a display panel to evaluate the visibility.

Polarizing plates 1-56 were produced by using each antireflection film described above and a cellulose ester optical compensation film, KC8UCR-5 (produced by KONICA MINOLTA, OPTO, INC.).

(a) Production of Polarizing Film

100 weight parts of polyvinyl alcohol having a saponification degree of 99.95% and polymerization degree of 2400 (hereafter referred to as PVA) was mixed with 10 weight parts of glycerin and 170 weight parts of pure water. The mixture was melted, kneaded, defoamed and melt-extruded from a T-die on a metal roll to form a film. The film was dried and heat treated to obtain a PVA film having an average thickness of 40 μm, water content of 4.4% and a film width of 3 m.

The PVA film was continuously subjected to preliminary swelling, dyeing, uniaxial wet stretching, fixing, drying and heat treating to form a polarization film. Namely, the PVA film was immersed in 30° C. water for 30 seconds for preliminary swelling; further immersed in an 35° C. aqueous solution containing 0.4 g/L of iodine and 40 g/L of potassium iodide for 3 minutes; uniaxially stretched in a stretch ratio of 6 with a tension of 700 N/m in a 50° C., aqueous solution of 4% of boric acid; immersed in a 30° C. aqueous solution containing 40 g/L of potassium iodide, 40 g/L of boric acid and 10 g/L of zinc chloride, for fixing; dried with 40° C. hot air; and heat treated at 100° C. for 5 miutes. The obtained polarizing film exhibited the following properties: average thickness: 13 μm; transmittance 43.0%; polarization degree: 99.5%; and dichroic ratio: 40.1.

(b) Production of Polarizing Plate

By pasting each polarizing film with a polarizing plate protective film, polarizing plates 1-56 were produced according to the following processes 1-5.

Process 1: An optical compensation film and an antireflection film were immersed in a 60° C. aqueous solution of 2 mol/L of sodium hydroxide for 90 seconds followed by washing and drying. The surface of the antireflection film where the antireflection layer was formed was protected by covering with a peelable protective film.

Process 2: The above described polarizing film was immersed in a polyvinyl alcohol adhesive solution having a solid content of 2% by weight for 1-2 seconds.

Process 3: Excess adhesive stuck to the polarizing film in process 2 was lightly removed and was laminated between the optical compensation film and the antireflection film both of which were subjected to alkali treatment.

Process 4: The laminated films in process 3 were pasted each other by pressing with 20-30 N/cm² between two rollers rotating in a rate of 2 m/min. A special attention was paid not to take in air between the films.

Process 5:The pasted films in process 4was dried in a 80° C. drying oven for two minutes to obtain a polarizing plate.

The polarizing plate provided on the outermost surface of a commercially available liquid crystal display panel (VA mode) was carefully removed. With adjusting the polarizing direction, each of the polarizing plates 1-56 was pasted to the surface of the above liquid crystal display panel.

Each of liquid crystal display panels 1-56 prepared as above was placed on a desk of the height of 80 cm from the floor. 10 sets of day light emitting straight fluorescent tubes (FLR40S·D/M-X produced by MATSUSHITA ELECTRIC INDUSTRIAL CO., LTD., each set containing two 40 W fluorescent tubes) were equipped on the ceiling of a height of 3 m from the floor with intervals of 1.5 m, so that the fluorescent tubes were placed behind the observer who was in front of the liquid crystal display panel and watching the display. The visibility of the display was evaluated under the condition where the light from the fluorescent tubes came from the direction 25° apart from the direction vertical to the desk. Evaluation criteria are as follows:

A: Reflection of the nearest fluorescent tubes are not disturbing ant characters of 8 point or less are clearly recognized

B: Reflection of the nearest fluorescent tubes are slightly disturbing, however, farer fluorescent tubes are not felt uneasy and characters of 8 point or less can be managed to be recognized

C: Even reflection of farer fluorescent tubes are somewhat disturbing and characters of 8 point or less are difficult to recognized

D: Reflection of the fluorescent tubes are obviously disturbing, and characters of 8 point or less superimposed on the reflection of florescent tube cannot be recognized at all

<<Results of Evaluation>>

Each of the antireflection films of the present invention and liquid crystal display panels using the polarizing plates of the present invention showed evaluation of B or more, and the visibilities were superior to those of the comparative example.

What is claimed is:

1. An antireflection film comprising a transparent substrate film having thereon a hard coat layer having a layer thickness of 8 to 20 μm, a high refractive index layer having a refractive index higher than a refractive index of the substrate film and a low refractive index layer having a refractive index lower than the refractive index of the substrate film, wherein
(i) the high refractive index layer is formed by applying a coating solution containing the following (a) to (c);
(ii) the low refractive index layer is formed by applying a coating solution containing the following (d) and (e);
(iii) the antireflection film is heat treated,
wherein
(a) metal oxide particles having an average primary particle diameter of 10 to 200 nm;
(b) a metal compound;
(c) an ionizing radiation curable resin;
(d) an organosilicon compound represented by Formula (1), a hydrolyzed compound of the organosilicon compound, a decomposed compound of the organosilicon compound or a polycondensed compound of the organosilicon compound,
Si(OR)₄ Formula (1)
wherein R represents an alkyl group; and
(e) hollow silica particles each having an outer shell, and a void or a porous portion in the inside.

2. The antireflection film of claim 1, wherein R represents an alkyl group having 1 to 4 carbon atoms.

3. The antireflection film of claim 1, wherein
the transparent substrate film comprises a plasticizer and a cellulose ester; and
a free volume radius determined by positron annihilation lifetime spectroscopy in the cellulose ester is in the range of 0.250 to 0.310 nm.

4. A method for producing an antireflection film comprising the steps of:
(i) producing a transparent substrate film by casting a dope on a support;
(ii) forming a hard coat layer having a thickness of 8 to 20 μm on the transparent substrate film;
(iii) forming a high refractive index layer having a refractive index higher than a refractive index of the substrate film by applying a coating solution containing the following (a) to (c);
(iv) forming a low refractive index layer having a refractive index lower than the refractive index of the substrate film by applying a coating solution containing the following (d) and (e); and (v) heat treating the antireflection film, wherein
(a) metal oxide particles having an average primary particle diameter of 10 to 200 nm;
(b) a metal compound;
(c) an ionizing radiation curable resin;
(d) an organosilicon compound represented by Formula (1), a hydrolyzed compound of the organosilicon compound, a decomposed compound of the organosilicon compound or a polycondensed compound of the organosilicon compound,
Si(OR)₄ Formula (1)
wherein R represents an alkyl group; and
(e) hollow silica particles each having an outer shell, and a void or a porous portion in the inside.

5. The method of claim 4, wherein R represents an alkyl group having 1 to 4 carbon atoms.

6. The method of claim 4, wherein the heat treatment is carried out after the antireflection film is wound in a roll.

7. The method of claim 4, wherein the heat treatment is carried out at a temperature of 50 to 150° C. for a duration of 1 to 30 days.

8. The method of claim 4, wherein
a free volume radius determined by positron annihilation lifetime spectroscopy in the transparent substrate film is in the range of 0.250 to 0.310 nm.

9. The method of claim 4, wherein the step (i) comprises the steps of:
(i-1) drying the transparent substrate film until an amount of a residual solvent decreases to 0.3% after the dope is cast; and
(i-2) treating the transparent substrate film at a temperature of 105 to 155° C. under an atmosphere of not less than 12 times/h of atmosphere replacement rate.

10. A polarizing plate having the antireflection film of claim 1 on one surface of a polarizing film and an optical compensation film on the other surface.

11. A display having the antireflection film of claim 1.

12. A display having the polarizing plate of claim 10.
